(19) United States
(12) Patent Application Publication
(10) Pub. No.: US 2024/0388962 A1
(43) Pub. Date: Nov. 21, 2024

(54) Packet Tunneling in a Wireless Communication Network

(71) Applicant: TELEFONAKTIEBOLAGET LM, Stockholm (SE)

(72) Inventors: Du Ho Kang, Sollentuna (SE); Paul Schliwa-Bertling, Ljungsbro (SE); Jose Luis Pradas, Stockholm (SE)

(21) Appl. No.: 18/261,553

(22) PCT Filed: Jan. 13, 2022
(86) PCT No.: PCT/SE2022/050022

§ 371 Date: Jul. 14, 2023

Related U.S. Application Data
(60) Provisional application No. 63/137,719, filed on Jan. 14, 2021.

(51) Int. Cl. H04W 28/06; H04L 47/2475; H04L 47/34; H04W 72/512

(52) U.S. Cl. CPC H04W 28/065; H04L 47/2475; H04L 47/34; H04W 72/512

(57) ABSTRACT

A transmit network node (14, 20) is configured for use in a wireless communication network (10). The transmit network node (14, 20) tunnels packets (18) from the transmit network node (14, 20) to a receive network node (20, 14) in the wireless communication network (10). The transmit network node (14, 20) also transmits, to the receive network node (20, 14), signaling (26) that indicates which tunneled packets (18) carry application layer data from the same application layer packet (16), how many tunneled packets (18) carry application layer data from the same application layer packet (16), and/or a size of an application layer packet (16). Based on the signaling (26), the receive network node (20, 14) in some embodiments schedules transmission of the tunneled packets (18) from the receive network node (20, 14) and/or allocates radio resources for transmission of the tunneled packets (18) from the receive network node (20, 14) towards a wireless device (12) served by the receive network node (20, 14).

### TECHNICAL FIELD

The present application relates generally to a wireless communication network, and relates more particularly to data transmission in such a network.

### BACKGROUND

New applications such as extended reality (XR) and cloud gaming generate large application layer packets, also referred to as protocol data units (PDUs). The large nature of an application layer PDU increases the likelihood that the same application layer PDU will need to be segmented across multiple, lower-layer packets, for tunneling from one network node to another. The lower-layer packets may for instance take the form of Internet Protocol (IP) packets formed from the same application layer packet. Regardless, this segmentation threatens timely delivery of the application layer packet, a problem that is exacerbated if the application generating the packet has strict latency requirements.

### SUMMARY

Some embodiments herein account for lower layer delays (e.g., at an IP level) in order to meet application layer quality of service requirements, e.g., application layer latency requirements. For example, some embodiments herein signal which tunneled packets (e.g., which IP Packets) carry user data from the same application layer packet, how many tunneled packets carry user data from the same application layer packet, and/or a size of an application layer packet. Some embodiments exploit this signaling for transmission scheduling and/or radio resource allocation, e.g., as needed in order to meet application layer quality of service requirements.

More particularly, embodiments herein include a method performed by a transmit network node configured for use in a wireless communication network. The method comprises tunneling packets from the transmit network node to a receive network node in the wireless communication network. The method also comprises transmitting, from the transmit network node to the receive network node, signaling that indicates which tunneled packets carry application layer data from the same application layer packet, how many tunneled packets carry application layer data from the same application layer packet, and/or a size of an application layer packet.

In some embodiments, tunneling packets comprises tunneling the packets within General Packet Radio Service Tunneling Protocol, GTP, packets. In one or more of these embodiments, the signaling is included in GTP headers of the GTP packets that include the tunneled packets.

In some embodiments, the tunneled packets are Internet Protocol, IP, packets.

In some embodiments, the signaling indicates which tunneled packets carry application layer data from the same application layer packet. In one or more of these embodiments, the signaling indicates which tunneled packets carry application layer data from the same application layer packet by indicating, for each tunneled packet, whether the tunneled packet is the first packet segmented from an application layer packet. Additionally or alternatively, the signaling indicates which tunneled packets carry application layer data from the same application layer packet by indicating, for each tunneled packet, whether the packet is the last packet segmented from an application layer packet. Additionally or alternatively, the signaling may indicate which tunneled packets carry application layer data from the same application layer packet by indicating a sequence number for each tunneled packet, e.g., where different sequence numbers are associated with different application layer packets.

In some embodiments, the signaling indicates how many tunneled packets convey application layer data from the same application layer packet.

In some embodiments, the signaling indicates a size of an application layer packet.

In some embodiments, the transmit network node is a core network node.

In some embodiments, the transmit network node implements a user plane function, UPF.

In some embodiments, the transmit network node is a radio network node.

In some embodiments, the receive network node is a radio network node.

In some embodiments, the tunneled packets are downlink packets destined for a wireless device served by the wireless communication network.

In some embodiments, the tunneled packets are uplink packets originating from a wireless device served by the wireless communication network.

Other embodiments herein include a method performed by a receive network node configured for use in a wireless communication network. The method comprises receiving, at the receive network node, packets tunneled from a transmit network node in the wireless communication network. The method also comprises receiving, at the receive network node, from the transmit network node, signaling that indicates which tunneled packets carry application layer data from the same application layer packet. Additionally or alternatively, the signaling indicates how many tunneled packets carry application layer data from the same application layer packet. Additionally or alternatively, the signaling indicates a size of an application layer packet.

In some embodiments, receiving packets tunneled from the transmit network node comprises receiving the packets within General Packet Radio Service Tunneling Protocol, GTP, packets. In one or more of these embodiments, the signaling is included in GTP headers of the GTP packets that include the tunneled packets.

In some embodiments, the tunneled packets are Internet Protocol, IP, packets.

In some embodiments, the signaling indicates which tunneled packets carry application layer data from the same application layer packet. In one or more of these embodiments, the signaling indicates which tunneled packets carry application layer data from the same application layer packet by indicating, for each tunneled packet, whether the tunneled packet is the first packet segmented from an application layer packet. Additionally or alternatively, the signaling indicates which tunneled packets carry application layer data from the same application layer packet by indicating, for each tunneled packet, whether the packet is the last packet segmented from an application layer packet. Additionally or alternatively, the signaling may indicate which tunneled packets carry application layer data from the same application layer packet by indicating a sequence number for each tunneled packet, e.g., where different sequence numbers are associated with different application layer packets.

In some embodiments, the signaling indicates how many tunneled packets convey application layer data from the same application layer packet.

In some embodiments, the signaling indicates a size of an application layer packet.

In some embodiments, the transmit network node is a core network node.

In some embodiments, the transmit network node implements a user plane function, UPF.

In some embodiments, the transmit network node is a radio network node.

In some embodiments, the receive network node is a radio network node.

In some embodiments, the tunneled packets are downlink packets destined for a wireless device served by the wireless communication network.

In some embodiments, the method further comprises, based on the signaling, scheduling transmission of the tunneled packets from the receive network node towards a wireless device served by the receive network node. In one or more of these embodiments, scheduling transmission comprises scheduling transmission of each tunneled packet carrying application layer data from the same application layer packet based on one or more of the same application layer quality of service requirements. In one or more of these embodiments, scheduling transmission of each tunneled packet carrying application layer data from the same application layer packet based on one or more of the same quality of service requirements comprises scheduling transmission of each tunneled packet carrying application layer data from the same application layer packet based on the same application layer latency requirement. In one or more of these embodiments, scheduling transmission of each tunneled packet carrying application layer data from the same application layer packet based on the same application layer latency requirement comprises scheduling transmission of each tunneled packet carrying application layer data from the same application layer packet based on the application layer latency requirement of whichever of the tunneled packets carrying application layer data from the same application layer packet was received at the receive network node first.

In some embodiments, the method further comprises, based on the signaling, allocating radio resources for transmission of the tunneled packets from the receive network node towards a wireless device served by the receive network node. In one or more of these embodiments, allocating radio resources comprises deciding how many radio resources to allocate for the transmission. Additionally or alternatively, allocating radio resources comprises deciding when to allocate radio resources for the transmission.

In some embodiments, the tunneled packets are uplink packets originating from a wireless device served by the wireless communication network.

Embodiments herein further include corresponding apparatus, computer programs, and carriers of those computer programs.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a block diagram of signaling according to some embodiments for indicating whether a packet is the first and/or last packet segmented from an application layer packet.

FIG. 3 is a block diagram of signaling according to some embodiments for indicating a sequence number of an application layer packet from which a packet was segmented.

FIG. 4 is a block diagram of signaling according to some embodiments for indicating how many tunneled packets convey application layer data from the same application layer packet and/or a size of an application layer packet.

FIG. 5 is a block diagram of signaling according to other embodiments for indicating whether a packet is the first and/or last packet segmented from an application layer packet.

FIG. 6 is a block diagram of user plane interfaces in a wireless communication network according to some embodiments.

FIG. 7 is a block diagram of multi-connectivity operation according to some embodiments.

FIG. 8 is a block diagram of a split radio network node according to some embodiments.

FIG. 9 is a block diagram of a GTP header according to some embodiments.

FIG. 10 is a block diagram of a signaling message according to some embodiments.

FIG. 11 is a graph of frame arrival times and frame latency according to some embodiments.

FIG. 12 is a graph of a number of transport blocks for each frame according to some embodiments.

FIG. 13 is a block diagram of the impact of application packet size on the ability to meet latency requirements according to some embodiments.

FIG. 14 is a logic flow diagram of a method performed by a transmit network node according to some embodiments.

FIG. 15 is a logic flow diagram of a method performed by a receive network node according to some embodiments.

FIG. 16 is a block diagram of a network node according to some embodiments.

FIG. 17 is a block diagram of a wireless communication network according to some embodiments.

FIG. 18 is a block diagram of a user equipment according to some embodiments.

FIG. 19 is a block diagram of a virtualization environment according to some embodiments.

### DETAILED DESCRIPTION

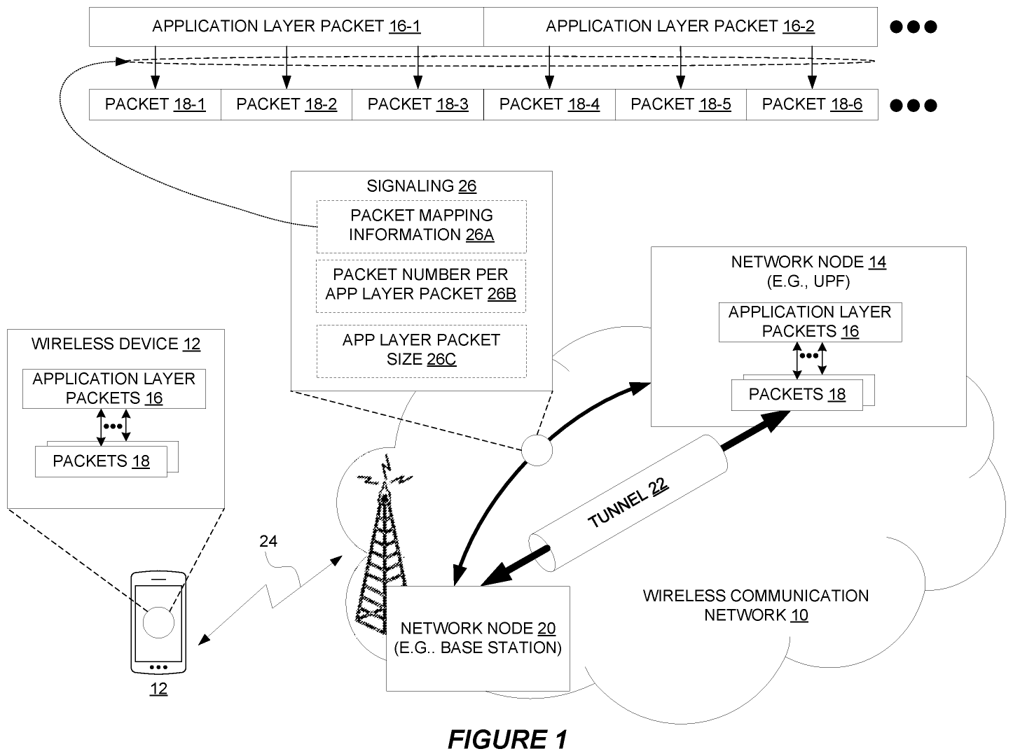

FIG. 1 shows a wireless communication network 10 that serves a wireless device 12 according to some embodiments. The wireless communication network 10 may for instance be a 5G network.

In some embodiments, the wireless device 12 transmits application layer data (in an uplink direction) to a network node 14 in the wireless communication network 10, e.g., which may be a core network node such as a network node implementing a user plane function (UPF). Alternatively or additionally, network node 14 may transmit application layer data (in a downlink direction) towards the wireless device 12. The application layer data may for instance be data of an extended reality (XR) or cloud gaming application. The application layer data may also be referred to as user data or user plane data, e.g., to distinguish the data from control signaling or control plane data.

To transmit the application layer data towards the wireless device 12 in the downlink direction, network node 14 packetizes the application layer data into application layer packets 16, e.g., application layer protocol data units (PDUs). Network node 14 may then further segment each application layer packet 16 into multiple packets 18, e.g., at a lower layer that is one or more layers below the application layer in a protocol stack. Where this segmentation happens at an Internet Protocol (IP) layer, for instance, the packets 18 may be IP packets. Regardless, as shown in FIG. 1, network node 14 may for example segment application layer packet 16-1 into packets 18-1, 18-2, and 18-3, such that packets 18-1, 18-2, and 18-3 each convey application layer data from the same application layer packet 16-1. Similarly, network node 14 may segment application layer packet 16-2 into packets 18-4, 18-5, and 18-6, such that packets 18-4, 18-5, and 18-6 each convey application layer data from the same application layer packet 16-2. In these and other embodiments, segmentation of an application layer packet 16 may be performed in a certain order and/or result in a certain ordering of packets 18 carrying the application layer data from that application layer packet 16. In this example, then, packet 18-1 is the first packet 18 segmented from application layer packet 16-1, packet 18-2 is the second packet 18 segmented from application layer packet 16-1, and packet 18-3 is the third (and last) packet 18 segmented from application layer packet 16-1. Similarly, packet 18-4 is the first packet 18 segmented from application layer packet 16-2, packet 18-5 is the second packet 18 segmented from application layer packet 16-2, and packet 18-6 is the third (and last) packet 18 segmented from application layer packet 16-2.

In any event, with the application layer packets 16 segmented into packets 18, the network node 14 transmits those packets 18 to another network node in the wireless communication network 10; namely, network node 20, which may for instance be a radio network node in a radio access network of the wireless communication network 10. To do so, network node 14 tunnels the packets 18 to network node 20. As shown in this regard, network node 14 transmits the packets 18 through a tunnel 22 between the network nodes 14, 20. In embodiments where the tunnel 22 is a Generic Packet Radio Service (GPRS) Tunneling Protocol (GTP) tunnel, for example, tunneling the packets 18 to network node 20 amounts to tunneling the packets 18 within GTP packets. This may involve wrapping the packets 18 with a GTP header such that each GTP packet comprises a respective one of the packets 18 wrapped in a GTP header. Regardless, with the packets 18 tunneled from network node 14 to network node 20, those packets 18 may be appropriately referred to as tunneled packets 18.

Having received the tunneled packets 18 from network node 14, network node 20 in turn transmits the packets 18 on to the wireless device 12, e.g., over a radio interface 24. Network node 20 in this regard may allocate radio resources on the radio interface 24 for transmitting the packets 18 to the wireless device 12 and/or may schedule transmission of the packets 18 to the wireless device 12. The wireless device 12 correspondingly receives the packets 18 from network node 20 and forms application layer packets 16 from those received packets 18.

Application layer data may alternatively or additionally be communicated in the uplink direction from the wireless device 12 to the network node 14 in a similar way. In particular, to transmit application layer data from the wireless device 12 to network node 14 in the uplink direction, the wireless device 12 packetizes the application layer data into application layer packets 16, and segments each application layer packet 16 as needed into multiple packets 18, e.g., at a lower layer such as the IP layer. The wireless device 12 then transmits the packets 18 to network node 20 over the radio interface 24. Network node 20 in turn tunnels the received packets 18 to network node 14 via tunnel 22, whereupon network node 14 forms application layer packets 16 from packets 18.

No matter the direction in which the application layer data is communicated, then, packets 18 that convey application layer data are tunneled between network nodes 14 and 20. When tunneled from network node 14 to network node 20 in the downlink direction, network node 14 is referred to as the transmit network node and network node 20 is referred to as the receive network node, since network node 14 is the node transmitting the packets 18 and network node 20 is the node receiving the packets 18. Conversely, when tunneled from network node 20 to network node 14 in the uplink direction, network node 20 is referred to as the transmit network node and network node 14 is referred to as the receive network node.

In this context, the transmit network node in some embodiments herein transmits signaling 26 to the receive network node in association with tunneling the packets 18 to the receive network node. This signaling 26 generally indicates information about the application layer packets 16, the packets 18 conveying the application layer data, and/or the relation between the application layer packets 16 and the packets 18 into which those application layer packets 16 are segmented. In one or more embodiments, the signaling 26 is communicated at a layer at which the tunnel 22 is implemented, i.e., the signaling is tunnel layer signaling. For example, where the tunneling is implemented as a GTP tunnel, the signaling 26 may be included in GTP headers of the GTP packets that include the tunneled packets 18. Regardless, as described more fully herein, some embodiments exploit this signaling for transmission scheduling and/or radio resource allocation, e.g., as needed in order to meet application layer quality of service requirements.

In some embodiments, the signaling 26 notably indicates which tunneled packets 18 carry application layer data from the same application layer packet 16. For example, the signaling 26 in the example of FIG. 1 would indicate that tunneled packets 18-1, 18-2, and 18-3 carry application layer data from the same application layer packet 16, namely application layer packet 16-1. And the signaling 26 would indicate that tunneled packets 18-4, 18-5, and 18-6 carry application layer data from the same application layer packet 16, namely application layer packet 16-2. As shown, the signaling 26 may include packet mapping information 26A that indicates this relation between tunneled packets 18 and application layer packets 16.

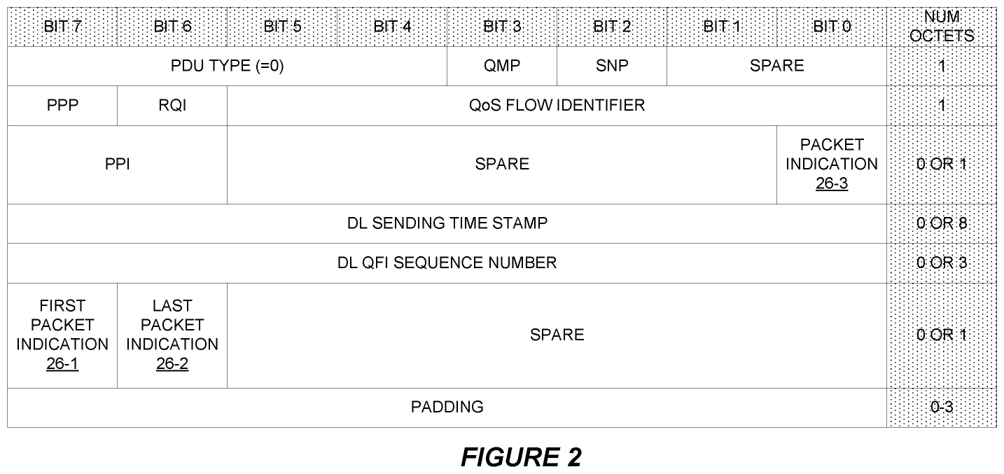

In some embodiments, the signaling 26 indicates which tunneled packets 18 carry application layer data from the same application layer packet 16 by indicating, for each tunneled packet 18, whether the tunneled packet 18 is the first packet segmented from an application layer packet 16 and/or whether the tunneled packet 18 is the last packet segmented from an application layer packet 16. FIG. 2 shows one example where the tunnel 22 is a GTP tunnel and the signaling 26 is included in the GTP headers of GTP packets carrying the tunneled packets 18, e.g., in the form of a Downlink PDU Session Information format defined to allow the NG-RAN to receive some control information elements which are associated with the transfer of a packet over the interface.

FIG. 2 in particular shows a GTP header that includes signaling 26 in the form of a first packet indication 26-1 and a last packet indication 26-2. The first packet indication 26-1 and the last packet indication 26-2 are each a 1-bit flag that can be set to a value of ‘1’ or ‘0’. A value of ‘1’ for the first packet indication 26-1 indicates that the tunneled packet 18 wrapped by this GTP header is the first packet segmented from an application layer packet 16, whereas a value of ‘0’ for the first packet indication 26-1 indicates that the tunneled packet 18 wrapped by this GTP header is not the first packet segmented from an application layer packet 16. Similarly, a value of ‘1’ for the last packet indication 26-2 indicates that the tunneled packet 18 wrapped by this GTP header is the last packet segmented from an application layer packet 16, whereas a value of ‘0’ for the last packet indication 26-2 indicates that the tunneled packet 18 wrapped by this GTP header is not the last packet segmented from an application layer packet 16.

In this embodiment, then, when both the first packet indication 26-1 and the last packet indication 26-2 are set to ‘1’, the tunneled packet 18 wrapped by the GTP header is both the first and last packet from an application layer packet. That is, in such a case there is only a single tunneled packet from a certain application layer packet. By contrast, when the first packet indication 26-1 is set to ‘1’ and the last packet indication 26-2 is set to ‘0’, the tunneled packet 18 wrapped by the GTP header is the first packet from a certain application layer packet, but not the last, meaning that the recipient can expect one or more other tunneled packets carrying application layer data from that same application layer packet. Accordingly, when the first packet indication 26-1 is set to ‘0’ and the last packet indication 26-2 is set to ‘0’, the tunneled packet 18 wrapped by the GTP header is neither the first nor the last packet from an application layer packet, again meaning that the recipient can expect one or more other tunneled packets carrying application layer data from that same application layer packet. Finally, when the first packet indication 26-1 is set to ‘0’ and the last packet indication 26-2 is set to ‘1’, the tunneled packet 18 wrapped by the GTP header is the last packet from a certain application layer packet, meaning that the recipient can expect that the next tunneled packet 18 received will carry application layer data from a different application layer packet than any previously received tunneled packets. In this implementation, then, the tunneled packets 18 that carry application layer data from the same application layer packet include: (i) a tunneled packet 18 wrapped by a GTP header with the first packet indication 26-1 set to ‘1’ and the last packet indication 26-2 set to ‘0’; (ii) the next received tunneled packet 18 wrapped by a GTP header with the first packet indication 26-1 set to ‘0’ and the last packet indication 26-2 set to ‘1’; and (iii) any tunneled packets 18 received in the interim between (i) and (ii) wrapped by a GTP header with both the first and second packet indications 26-1, 26-2 set to ‘0’. Accordingly, tunneled packets received in the interim between (i) and (ii) are implicitly considered as carrying application layer data from the same application layer packet 16 as (i) and (ii).

In the example of FIG. 1, then, the GTP header carrying packet 18-1 would have the first packet indication 26-1 set to ‘1’ and the last packet indication 26-2 set to ‘0’. The GTP header carrying packet 18-2 would have the first packet indication 26-1 set to ‘0’ and the last packet indication 26-2 set to ‘0’. The GTP header carrying packet 18-3 would have the first packet indication 26-1 set to ‘0’ and the last packet indication 26-2 set to ‘1’. Similarly, the GTP header carrying packet 18-4 would have the first packet indication 26-1 set to ‘1’ and the last packet indication 26-2 set to ‘0’. The GTP header carrying packet 18-5 would have the first packet indication 26-1 set to ‘0’ and the last packet indication 26-2 set to ‘0’. And the GTP header carrying packet 18-6 would have the first packet indication 26-1 set to ‘0’ and the last packet indication 26-2 set to ‘1’.

The example of FIG. 2 proves particularly efficient, especially when the tunneled packets 18 arrive sequentially. In some embodiments where the tunneled packets 18 are IP packets, in order to check whether segmented IP packets belong to the same application layer packet, a network node will decode the IP header to check its ‘identification field’.

FIG. 2 also shows that, in some embodiments, the signaling 26 further includes a packet indication 26-3 field that indicates whether or not the first and last packet indications 26-1 and 26-2 are present in the GTP header. A value of ‘1’ for the packet indication 26-3 indicates that the first and last packet indications 26-1 and 26-2 are present, where as value of ‘0’ indicates that the first and last packet indications 26-1 and 26-2 are not present.

Although illustrated as two fields, the first and last packet indications 26-1, 26-2 in other embodiments may be combined into a single field, i.e., one field comprising two bits may be defined for four different states corresponding to those described above.

Although FIG. 2 illustrated an example embodiment for a DL PDU SESSION INFORMATION frame, the embodiment may be additionally or alternatively extended to an UL PDU SESSION INFORMATION frame format that allows a UPF to receive some control information elements which are associated with the transfer of a packet over the interface.

In other embodiments, signaling 26 indicates which tunneled packets 18 carry application layer data from the same application layer packet 16 by alternatively or additionally indicating a sequence number for each tunneled packet 18, where different sequence numbers are associated with different application layer packets 16. For example, the signaling 26 may indicate a sequence number of ‘1’ for each of tunneled packets 18-1, 18-2, and 18-3, to indicate that those tunneled packets 18-1, 18-2, and 18-3 carry application layer data from the same application layer packet, namely application layer packet 16-1. And the signaling 26 may indicate a sequence number of ‘2’ for each of tunneled packets 18-4, 18-5, and 18-6, to indicate that those tunneled packets 18-4, 18-5, and 18-6 carry application layer data from the same application layer packet, namely application layer packet 16-2.

Note, here, that in some embodiments, the sequence number actually corresponds to and identifies a sequence number assigned to an application layer packet at the application layer. In this case, then, the signaling 16 may not only indicate which tunneled packets 18 carry application layer data from the same application layer packet, but may also identify which application layer packet is the one from which the tunneled packets 18 were segmented.

But in other embodiments the sequence number does not necessarily identify or correspond to an application layer packet sequence number assigned at the application layer; rather, the sequence number just serves as an index of sorts to logically group packets 18 that carry application layer data from the same application layer packet. In this case, then, the signaling 16 may only indicate which tunneled packets 18 carry application layer data from the same application layer packet, without also identifying which application layer packet is the one from which the tunneled packets 18 were segmented.

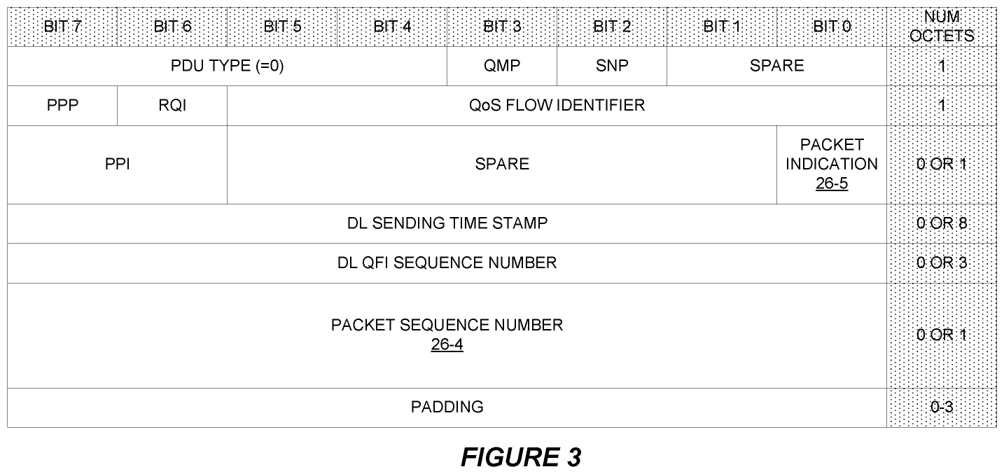

FIG. 3 shows one example of these embodiments. As shown, the GTP header wrapping each tunneled packet 18 includes a packet sequence number 26-4 field. This packet sequence number 26-4 indicates a sequence number common to all tunneled packets 18 that carry application layer data from the same application layer packet 16. For instance, a first set of tunneled packets 18 belonging to the same application layer packet will share the same marking e.g., sequence number 0, and a second set of tunneled packets 18 will have a different marking than the previous set of packets, but all packets in the second set belonging to a second application layer packet 16 will share the same marking, e.g., sequence number 1 in the GTP header. This frame index (or sequence number) will be incremented until the maximum index value is reached. When the maximum index is reached, a new index from 0 will be assigned to the new tunneled packets. The field above could also be combined with this field to also provide information about the first, middle, and last IP packets within a set of tunneled packets belonging to one application layer packet.

Using the DL PDU SESSION INFORMATION, one example of indicating packets that belong to the same application PDU by a packet sequence number is shown below where a new information is introduced indicating that the ‘Packet Sequence Number’ is included by means of a ‘Packet Sequence Number Indication’:

FIG. 3 also shows that, in some embodiments, the signaling 26 further includes a packet indication 26-5 field that indicates whether or not the packet sequence number 26-4 is present in the GTP header. A value of ‘1’ for the packet indication 26-5 indicates that the packet sequence number 26-4 is present, whereas value of ‘0’ indicates that the packet sequence number 26-4 is not present.

Alternatively or additionally to the signaling 26 indicating which tunneled packets 18 carry application layer data from the same application layer packet 16, the signaling 26 may indicate how many tunneled packets 18 carry application layer data from the same application layer packet 16. So, in the example of FIG. 1, the signaling 26 may indicate that 3 tunneled packets 18 carry application layer data from the same application layer packet 16, e.g., since application layer packet 16-1 is segmented into 3 packets 18-1, 18-2, and 18-3.

Alternatively or additionally, the signaling 26 may indicate a size of an application layer packet 16, e.g., in bytes, bits, or octets. The indicated size may be an exact size of an application layer packet 16 or may be a maximum size of an application layer packet 16.

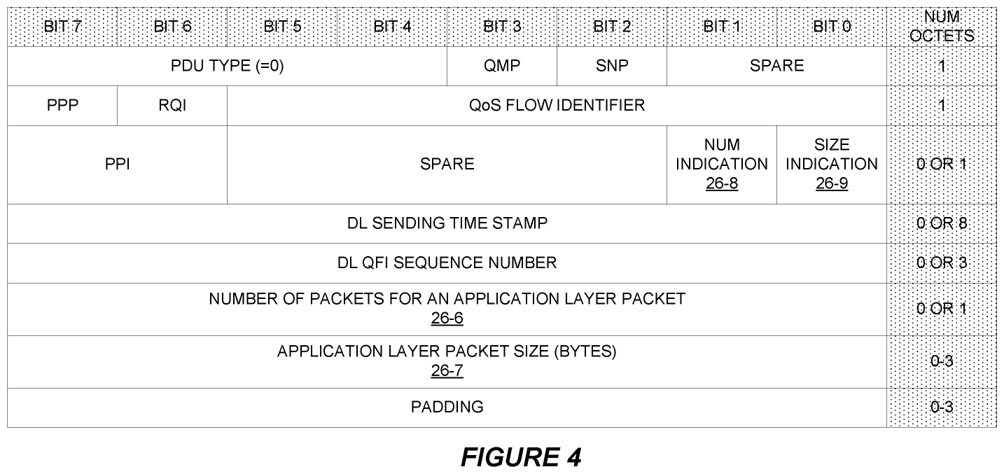

FIG. 4 shows an example where the signaling 26 indicates how many tunneled packets 18 carry application layer data from the same application layer packet 16, and also indicates a size of an application layer packet 16. As shown, the GTP header includes a field 26-6 indicating a number of packets for an application layer packet. The GTP header also includes a field 26-7 indicating an application layer packet size (in bytes). In some embodiments, the GTP header includes a num indication 26-8 field that indicates whether or not field 26-6 is present and/or includes a size indication 26-9 field that indicates whether or not field 26-7 is present. Of course, although the GTP header is shown in this example as including both field 26-6 and 26-7, the two fields could be added independently. Also, the number of octets for each field may vary depending on the number of tunneled packets to be indicated or the maximum size of packets in bytes/bits to be reported.

In any event, according to some embodiments, the receive network node that receives the tunneled packets 18 and the signaling 26 exploits the signaling 26 for scheduling the transmission of the tunneled packets 18 from the receive network node. For example, where the receive network node is a radio network node, and the tunneled packets 18 are downlink packets destined for the wireless device 12, the radio network node may schedule the transmission of the tunneled packets 18 towards the wireless device 12 based on the signaling 26. In embodiments where the signaling 26 indicates which tunneled packets 18 carry application layer data from the same application layer packet, for instance, this may entail scheduling transmission of each tunneled packet 18 carrying application layer data from the same application layer packet based on one or more of the same application layer quality of service requirements, e.g., based on the same application layer latency requirement, such as the application layer latency requirement of whichever of the tunneled packets 18 carrying application layer data from the same application layer packet was received at the receive network node first.

Alternatively or additionally, according to some embodiments, the receive network node that receives the tunneled packets 18 and the signaling 26 exploits the signaling 26 for allocating radio resources for transmission of the tunneled packets 18 from the receive network node towards the wireless device 12. This may entail for instance deciding how many radio resources to allocate for the transmission and/or when to allocate radio resources for the transmission. This allocation decision may for instance be based on how many tunneled packets 18 carry application layer data from the same application layer packet 16 and/or based on a size of an application layer packet 16.

By performing scheduling and/or radio resource allocation in this way based on the signalling 26, some embodiments advantageously ensure application layer quality of service requirements will be met, even if lower layer delays occur (e.g., at an IP level).

Note that, in the embodiments shown in FIG. 1, the signaling 26 is transmitted between network nodes 14, 20, where one of the network nodes is a radio network node and one of the network nodes is not. In one such embodiment, network node 14 implements a user plane function (UPF) and network node 20 is a radio network node, e.g., a gNodeB. In a split radio network architecture, network node 20 may more particularly be a Central Unit (CU) User Plane (CU-UP) network node. In this case, then, the tunneled packets 18 and/or the signaling 26 may be communicated over an N3/NG-U interface between the network nodes 14, 20, e.g., as specified in 3GPP TS 38.415v16.2.0.

In other embodiments not shown, though, both network nodes 14, 20 may be radio network nodes. For example, in some embodiments, network node 14 is CU-UP and network node 20 is a Distributed Unit (DU). In this case, the tunneled packets 18 and/or the signaling 26 may be communicated over an F1-U interface between the network nodes 14, 20, e.g., as specified in 3GPP TS 38.425v16.2.0. As another example, network nodes 14, 20 may both be CU-UPs associated with different NG-RAN/gNodeBs where Xn-U is established. In this case, the tunneled packets 18 and/or the signaling 26 may be communicated over an Xn-U interface between the network nodes 14, 20, e.g., as specified in 3GPP TS 38.425v16.2.0.

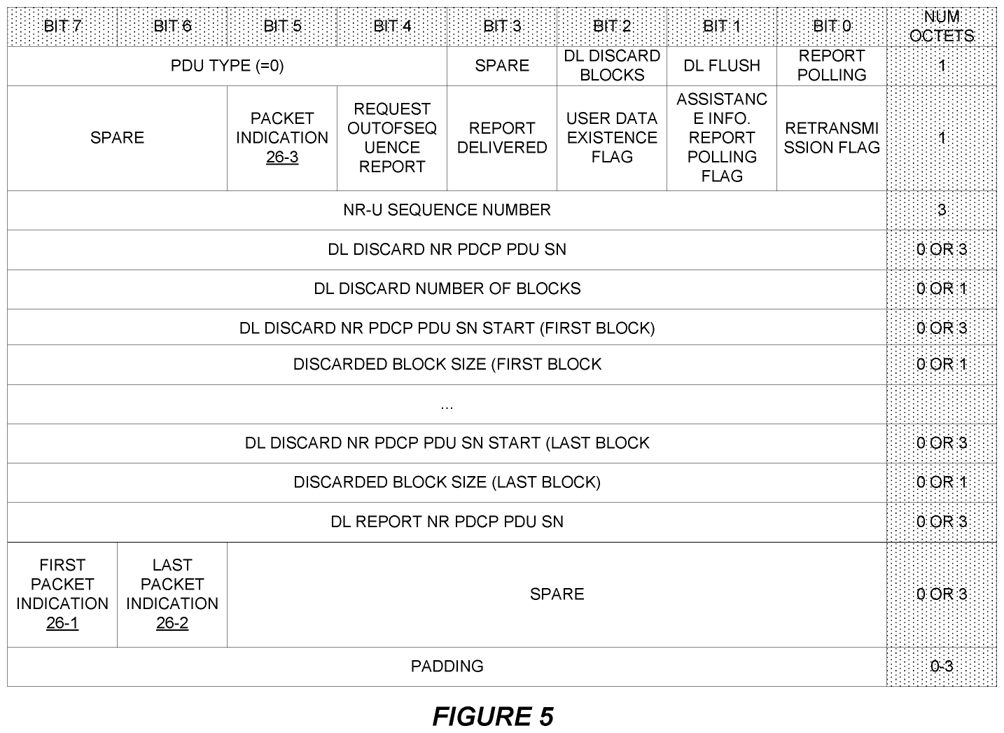

FIG. 5 shows one example implementation of signaling 26 communicated to a DU over the F1-U interface and the Xn-U to another NG-RAN. As a non-limiting example, from TS 38.425v16.2.0, FIG. 5 in particular shows the respective DL USER DATA frame as modified to include signaling 26 in the form of the first packet indication 26-1, the last packet indication 26-2, and/or packet indication 26-3 as described above with respect to FIG. 2. Although not shown, packet sequence number 26-4 may be added to FIG. 5, as described in FIG. 3. Alternatively or additionally, field 26-6 and/or field 26-7 may be added to FIG. 5, as described in FIG. 4.

Although embodiments herein may be applicable in any type of wireless communication network, some embodiments are particularly applicable in a 5G system. The 5G system is the fifth-generation of mobile communications, addressing a wide range of use cases from enhanced mobile broadband (eMBB) to ultra-reliable low-latency communications (URLLC) to massive machine type communications (mMTC). 5G includes the New Radio (NR) access stratum interface and the 5G Core Network (5GC). The NR physical and higher layers are reusing parts of the Long Term Evolution (LTE) specification, and to that adds needed components when motivated by new use cases.

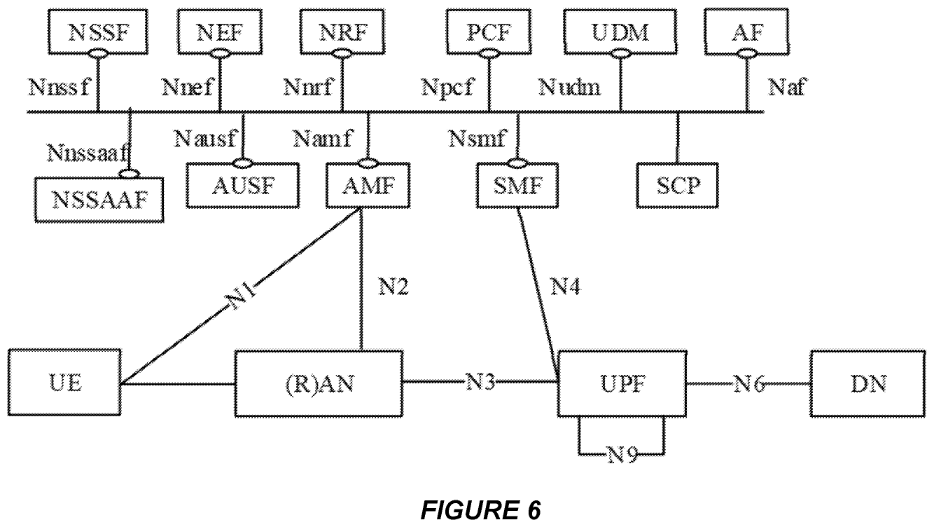

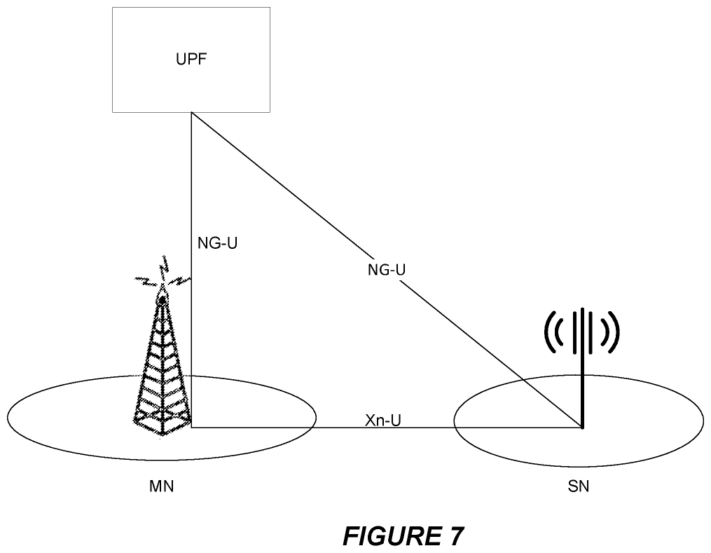

FIGS. 6 and 7 show the user plane interfaces for the NG-U interface, sometimes referred to as the N3 interface, between the UPF and the NG-RAN in a 5G network, as well as the Xn-U interface between two NG-RAN nodes. In particular, FIG. 6 shows the user plane connectivity for a RAN with a 5GC on N3. And FIG. 7 shows user plane connectivity for multi-radio dual connectivity with 5GC.

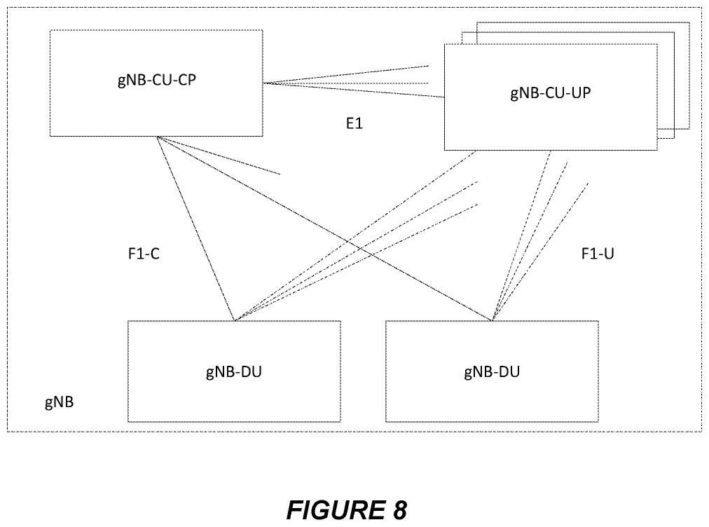

FIG. 8 shows the overall architecture for separation of gNB-CU-CP and gNB-CU-UP. The gNB-CU-UP is connected to the gNB-DU through the F1-U interface. GTP-Uv1 as specified in TS 29.281v16.0.0 is used on the N3/NG-U interface between the UPF and the NG-RAN/CU-UP as well as on the F1-U interface between the CU-UP and the DU and the CU-UPs configured with different NG-RAN/gNBs where Xn-U is established. However, the details on the content of the GTP-U headers is specified in TS 38.415v16.2.0 for the NG-U/N3 and the TS 38.425v16.2.0 is applicable for the F1-U and XN-U interface.

The GTP-U protocol entity provides packet transmission and reception services to user plane entities in the Radio Network Controller (RNC), Serving GPRS Support Node (SGSN), Gateway GPRS Support Node (GGSN), eNodeB, Serving Gateway (SGW), evolved Packet Data Gateway (ePDG), Packet Data Network Gateway (PGW), Trusted WLAN Access Network (TWAN), Mobility Management Entity (MME), gNB, N3 Interworking Function (N3IWF), and User Plane Function (UPF). The GTP-U protocol entity receives traffic from a number of GTP-U tunnel endpoints and transmits traffic to a number of GTP-U tunnel endpoints. There is a GTP-U protocol entity per IP address.

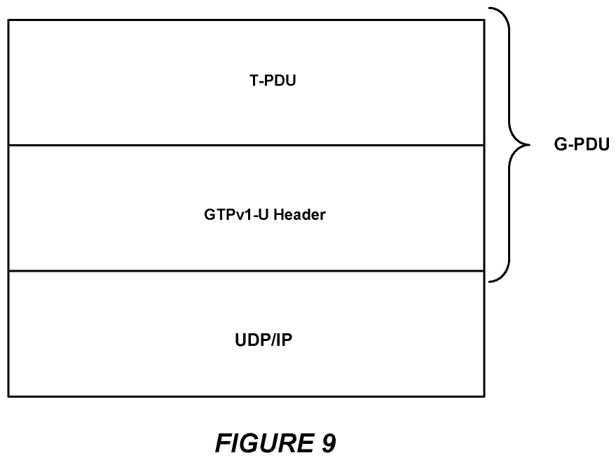

FIG. 9 shows the protocol stack for a GTP-PDU (i.e., a GTP packet) according to some embodiments, e.g., as specified in 3GPP TS 29.281. T-PDU may contain an IP Datagram, Ethernet or unstructured PDU Data frames as specified in 3GPP TS 23.501.

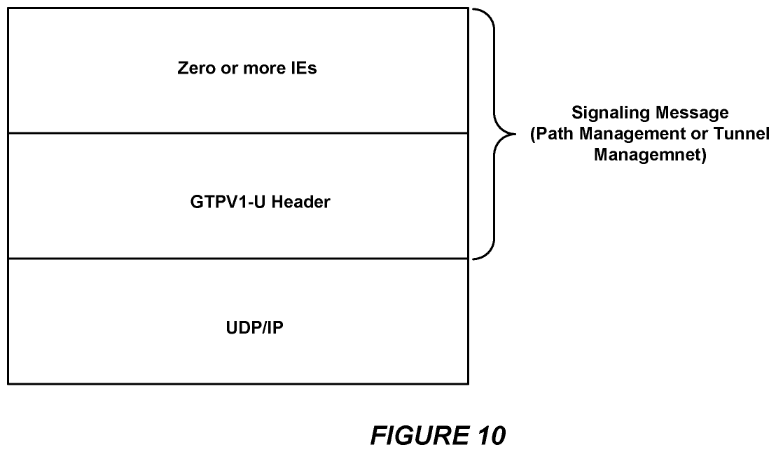

FIG. 10 shows the protocol stack for a GTP-PDU signaling message according to some embodiments.

A GTP-U header according to some embodiments may be as specified in 3GPP TS 29.281. It is a variable length header whose minimum length is 8 bytes. There are three flags that are used to signal the presence of additional optional fields: the PN flag, the S flag, and the E flag. The PN flag is used to signal the presence of N-PDU Numbers. The S flag is used to signal the presence of the GTP Sequence Number field. The E flag is used to signal the presence of the Extension Header field, used to enable future extensions of the GTP header, without the need to use another version number. If and only if one or more of these three flags are set, the fields Sequence Number, N-PDU, and Extension Header shall be present. The sender shall set all the bits of the unused fields to zero. The receiver shall not evaluate the unused fields. For example, if only the E flag is set to 1, then the N-PDU Number and Sequence Number fields shall also be present, but will not have meaningful values and shall not be evaluated.

The PDU session user plane protocol data is conveyed by GTP-U protocol means, more specifically, by means of the “GTP-U Container” GTP-U Extension Header as defined in TS 29.281.

Unless otherwise indicated, fields described herein (e.g., in FIGS. 2-4) which consist of multiple bits within an octet have the most significant bit located at the higher bit position. In addition, if a field spans several octets, most significant bits are located in lower numbered octets. On the NG interface, the frame is transmitted starting from the lowest numbered octet. Within each octet, the bits are sent according to decreasing bit position (bit position 7 first). Spare bits should be set to “0” by the sender and should not be checked by the receiver. The header part of the frame is always an integer number of octets. The payload part is octet aligned (by adding ‘Padding Bits’ when needed).

In this context, some embodiments may be particularly applicable for applications like extended reality (XR) and cloud gaming that require long scheduled transmission bursts, bounded latency, and/or high-rate transmissions. XR may refer to all real-and-virtual combined environments and human-machine interactions generated by computer technology and wearables, e.g., to generally refer to different types of realities, including Virtual Reality (VR), Augmented Reality (AR), Mixed Reality (MR), and the areas interpolated among them so as to range from partially sensory inputs to fully immersive VR.

The low-latency applications like XR and cloud gaming require bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

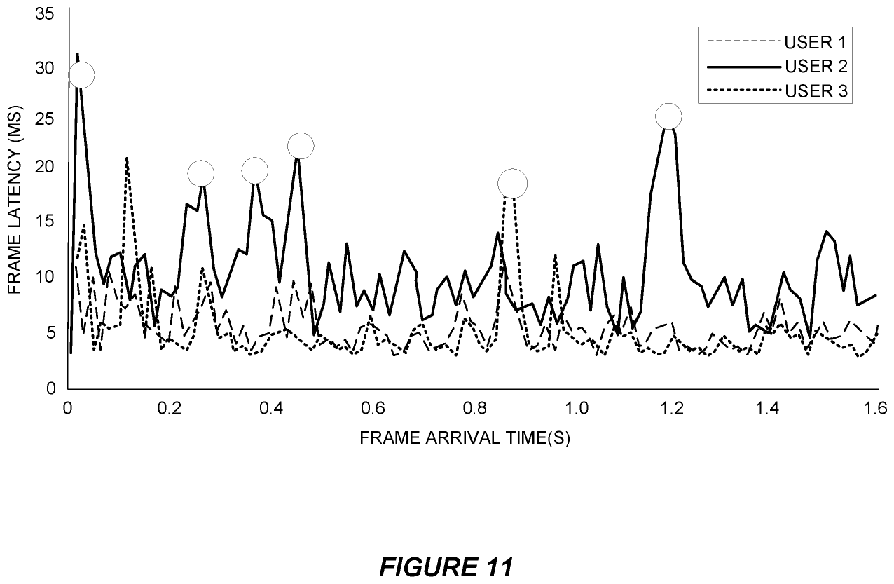

FIG. 11 shows an example of frame latency measured over a radio access network (RAN), excluding application & core network latencies. It can be seen that there exist frame latency spikes in the radio access network (RAN). The sources for the latency spikes may include queuing delay, time-varying radio environments, time-varying frame sizes, among others. Tools that can help to remove latency spikes are beneficial to enable better 5G support for this type of traffic.

In addition to bounded latency requirements, the applications like XR and cloud gaming also require high-rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

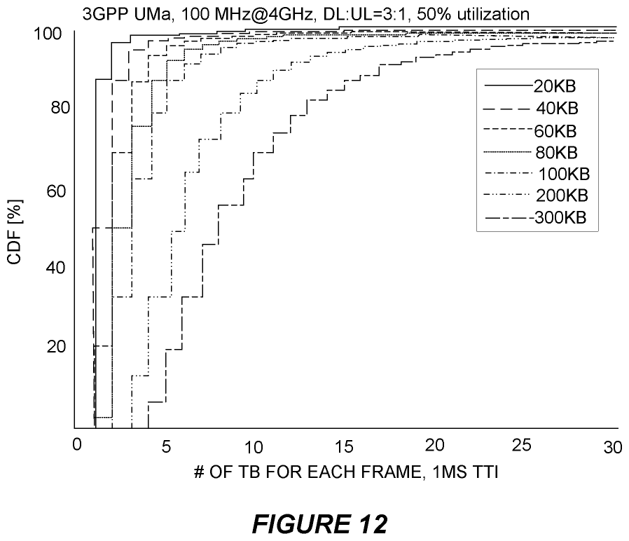

A large video frame is usually fragmented into smaller IP packets and transmitted as several transport blocks (TBs) over several TTIs in RAN. FIG. 12 shows an example of the cumulative distribution functions of the number of transport blocks required to deliver a video frame with a size ranging from 20 KB to 300 KB. For example, FIG. 12 shows that for delivering the frames with a size of 100 KB each, the median number of needed TBs is 5.

Some embodiments advantageously enable support of services with large application layer protocol data units (PDUs), such as low-latency XR services. Indeed, compared to other low-latency services such as Voice over IP (VOIP) and ultra-reliability low-latency communications (URLLC), XR will have a much larger application protocol data unit (PDU) size so that it will be common that there will be multiple Service Data Adaptation Protocol (SDAP) service data units (SDUs) from one application PDU. Here, SDAP SDUs correspond to IP packets as described above.

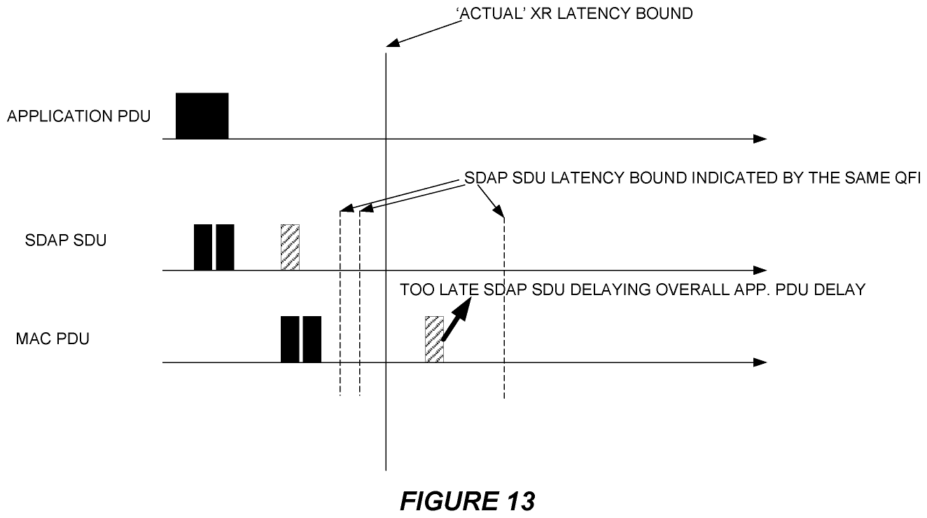

Some embodiments in particular address a problem with existing quality of service (QOS) handling which is based on static or semi-static configuration per flow so that it does not really differentiate the latency at the level of SDAP SDUs and also does not differentiate different application PDUs. In reality, different SDAP SDUs from the same XR flow will experience different latency over public Internet Protocol (IP) networks, i.e., IP jitters. At the same time, different SDUs can be from the same XR frame (or application PDU) from the same UE or can be from different XR frames from the same UE. The lack of information to differentiate application PDUs from the same XR user and SDAP SDUs from the same application PDU will heretofore mislead radio resource allocation. More specifically, FIG. 13 illustrates problems of static latency requirements for all SDAP SDUs from the existing QoS framework.

In FIG. 13, the same QoS Flow ID (QFI) for the first SDAP SDU and the last SDAP SDU will cause the late scheduling of the last SDAP SDU since the last SDU is marked with the same latency requirement as the first SDU, but arrives to the RAN later than the first SDU due to IP network congestion. This will exceed the common latency required for the corresponding application PDU of the XR frame marked by a solid line in the figure.

Certain aspects of the present disclosure and their embodiments may provide solutions to these or other challenges. As a specific example of the signaling 26 in FIG. 1, for instance, some embodiments introduce signaling for indicating XR application PDU information in a GTP-header in order to let the radio access network (RAN) be aware of that information, e.g., for radio resource allocation and early RAN traffic control. The GTP-U header may for example include a new frame indication for XR traffic detection in multiple segmented IP packets, e.g., so that the RAN can efficiently allocate and prioritize resources for an application PDU (i.e., frame).

By including this video frame indication in a GTP header, some embodiments ensure the RAN is aware of which IP packets are segmented from one XR application PDU, so that the RAN can efficiently prioritize related IP packets together for resource allocation and scheduling.

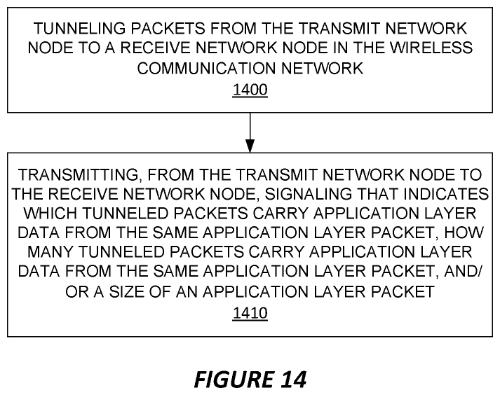

In view of the modifications and variations herein, FIG. 14 depicts a method performed by a transmit network node 14, 20 configured for use in a wireless communication network 10 in accordance with particular embodiments. The method includes tunneling packets 18 from the transmit network node 14, 20 to a receive network node 20, 14 in the wireless communication network 10 (Block 1400). With reference to FIG. 1, in some embodiments, the transmit network node is network node 14 and the receive network node is network node 20. In other embodiments, by contrast, the transmit network node is network node 20 and the receive network node is network node 14. The notation transmit network node 14, 20 and receive network node 20, 14, with the reference numbers in opposite positions, represents these alternative embodiments.

Regardless, the method also includes transmitting, from the transmit network node 14, 20 to the receive network node 20, 14, signaling 26 that indicates which tunneled packets 18 carry application layer data from the same application layer packet 16, how many tunneled packets 18 carry application layer data from the same application layer packet 16, and/or a size of an application layer packet 16 (Block 1410).

In some embodiments, tunneling packets 18 comprises tunneling the packets 18 within General Packet Radio Service Tunneling Protocol, GTP, packets. In one or more of these embodiments, the signaling 26 is included in GTP headers of the GTP packets that include the tunneled packets 18.

In some embodiments, the tunneled packets 18 are Internet Protocol, IP, packets.

In some embodiments, the signaling 26 indicates which tunneled packets 18 carry application layer data from the same application layer packet 16. In one or more of these embodiments, the signaling 26 indicates which tunneled packets 18 carry application layer data from the same application layer packet 16 by indicating, for each tunneled packet 18, whether the tunneled packet 18 is the first packet segmented from an application layer packet 16. Additionally or alternatively, the signaling 26 indicates which tunneled packets 18 carry application layer data from the same application layer packet 16 by indicating, for each tunneled packet 18, whether the packet is the last packet segmented from an application layer packet 16. Additionally or alternatively, the signaling 26 indicates which tunneled packets 18 carry application layer data from the same application layer packet 16 by indicating a sequence number for each tunneled packet 18. In this case, different sequence numbers are associated with different application layer packets 16.

In some embodiments, the signaling 26 indicates how many tunneled packets 18 convey application layer data from the same application layer packet 16.

In some embodiments, the signaling 26 indicates a size of an application layer packet 16.

In some embodiments, the transmit network node 14, 20 is a core network node. In one embodiment, for example, the transmit network node 14, 20 implements a user plane function, UPF. In other embodiments, the transmit network node 14, 20 is a radio network node.

In some embodiments, the receive network node 20, 14 is a radio network node.

In some embodiments, the tunneled packets 18 are downlink packets destined for a wireless device served 12 by the wireless communication network 10. In other embodiments, the tunneled packets 18 are uplink packets originating from a wireless device 12 served by the wireless communication network 10.

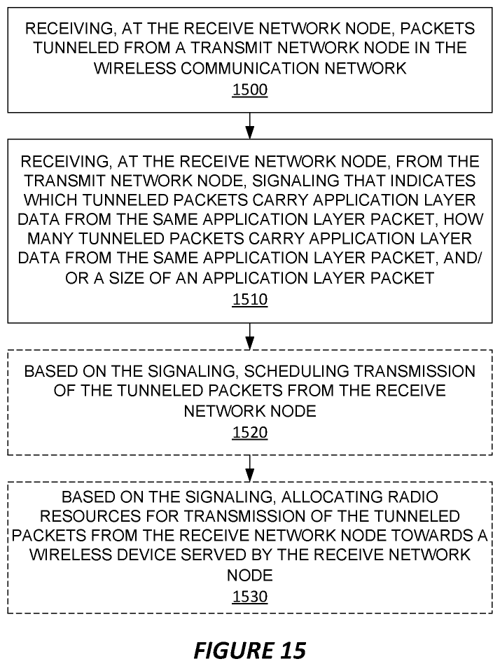

FIG. 15 depicts a corresponding method performed by a receive network node 20, 14 configured for use in a wireless communication network 10 in accordance with other particular embodiments. The method includes receiving, at the receive network node 20, 14, packets 18 tunneled from a transmit network node 14, 20 in the wireless communication network 10 (Block 1500). The method further includes receiving, at the receive network node 20, 14, from the transmit network node 14, 20, signaling 26 that indicates which tunneled packets 18 carry application layer data from the same application layer packet 16, how many tunnelled packets 18 carry application layer data from the same application layer packet 16, and/or a size of an application layer packet 16 (Block 1510).

In some embodiments, the method further comprises, based on the signaling 26, scheduling transmission of the tunneled packets 18 from the receive network node 20, 14, e.g., towards a wireless device 12 served by the receive network node 20, 14 (Block 1520). Alternatively or additionally, the method in some embodiments also comprises, based on the signaling 26, allocating radio resources for transmission of the tunneled packets 18 from the receive network node 20, 14 towards a wireless device 12 served by the receive network node 20, 14 (Block 1530).

In some embodiments, receiving packets 18 tunneled from the transmit network node 14, 20 comprises receiving the packets 18 within General Packet Radio Service Tunneling Protocol, GTP, packets. In one such embodiment, the signaling 26 is included in GTP headers of the GTP packets that include the tunneled packets 18.

In some embodiments, the tunneled packets 18 are Internet Protocol, IP, packets.

In some embodiments, the signaling 26 indicates which tunneled packets 18 carry application layer data from the same application layer packet 16. In one or more of these embodiments, the signaling 26 indicates which tunneled packets 18 carry application layer data from the same application layer packet 16 by indicating, for each tunneled packet 18, whether the tunneled packet 18 is the first packet segmented from an application layer packet 16. Additionally or alternatively, the signaling 26 indicates which tunneled packets 18 carry application layer data from the same application layer packet 16 by indicating, for each tunneled packet 18, whether the packet is the last packet segmented from an application layer packet 16. Additionally or alternatively, the signaling 26 indicates which tunneled packets 18 carry application layer data from the same application layer packet 16 by indicating a sequence number for each tunneled packet 18. In this case, different sequence numbers are associated with different application layer packets 16.

In some embodiments, the signaling 26 indicates how many tunneled packets 18 convey application layer data from the same application layer packet 16.

In some embodiments, the signaling 26 indicates a size of an application layer packet 16.

In some embodiments, the transmit network node 14, 20 is a core network node. In one embodiment, for example, the transmit network node 14, 20 implements a user plane function, UPF. In other embodiments, the transmit network node 14, 20 is a radio network node.

In some embodiments, the receive network node 20, 14 is a radio network node.

In some embodiments, the tunneled packets 18 are downlink packets destined for a wireless device served 12 by the wireless communication network 10. In other embodiments, the tunneled packets 18 are uplink packets originating from a wireless device 12 served by the wireless communication network 10.

Embodiments herein also include corresponding apparatuses. Embodiments herein for instance include a network node configured to perform any of the steps of any of the embodiments described above for network node 14 or network node 20, e.g., in the form of the transmit network node or the receive network node.

Embodiments also include a network node comprising processing circuitry and power supply circuitry. The processing circuitry is configured to perform any of the steps of any of the embodiments described above for network node 14 or network node 20, e.g., in the form of the transmit network node or the receive network node. The power supply circuitry is configured to supply power to the network node.

Embodiments further include a network node comprising processing circuitry. The processing circuitry is configured to perform any of the steps of any of the embodiments described above for network node 14 or network node 20, e.g., in the form of the transmit network node or the receive network node. In some embodiments, the network node further comprises communication circuitry.

Embodiments further include a network node comprising processing circuitry and memory. The memory contains instructions executable by the processing circuitry whereby the network node is configured to perform any of the steps of any of the embodiments described above for network node 14 or network node 20, e.g., in the form of the transmit network node or the receive network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

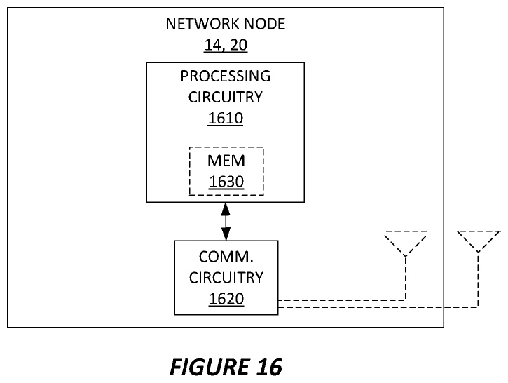

FIG. 16 for example illustrates a network node 14 or 20 as implemented in accordance with one or more embodiments. As shown, the network node 14 or 20 includes processing circuitry 1610 and communication circuitry 1620. The communication circuitry 1620 (e.g., radio circuitry) is configured to transmit and/or receive information to and/or from one or more other nodes, e.g., via any communication technology. Such communication may occur via one or more antennas that are either internal or external to the wireless device 1600. The processing circuitry 1610 is configured to perform processing described above, e.g., in FIG. 14 and/or FIG. 15, such as by executing instructions stored in memory 1630. The processing circuitry 1610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

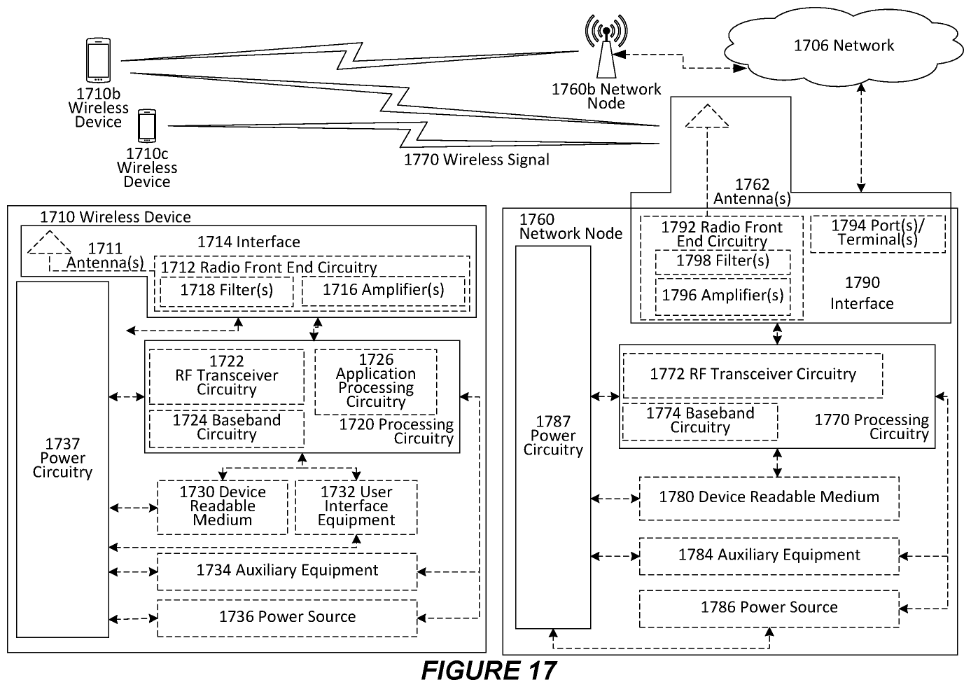

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network 1706, network nodes 1760 and 1760b, and WDs 1710, 1710b, and 1710c. In practice, a wireless network may further include any additional elements suitable to support communication between wireless devices or between a wireless device and another communication device, such as a landline telephone, a service provider, or any other network node or end device. Of the illustrated components, network node 1760 and wireless device (WD) 1710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1760 and WD 1710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node 1760 includes processing circuitry 1770, device readable medium 1780, interface 1790, auxiliary equipment 1784, power source 1786, power circuitry 1787, and antenna 1762. Although network node 1760 illustrated in the example wireless network of FIG. 17 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1760 are depicted as single boxes located within a larger box, or nested within multiple boxes, in practice, a network node may comprise multiple different physical components that make up a single illustrated component (e.g., device readable medium 1780 may comprise multiple separate hard drives as well as multiple RAM modules).

Similarly, network node 1760 may be composed of multiple physically separate components (e.g., a NodeB component and a RNC component, or a BTS component and a BSC component, etc.), which may each have their own respective components. In certain scenarios in which network node 1760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1760 may be configured to support multiple radio access technologies (RATs). In such embodiments, some components may be duplicated (e.g., separate device readable medium 1780 for the different RATs) and some components may be reused (e.g., the same antenna 1762 may be shared by the RATs). Network node 1760 may also include multiple sets of the various illustrated components for different wireless technologies integrated into network node 1760, such as, for example, GSM, WCDMA, LTE, NR, WiFi, or Bluetooth wireless technologies. These wireless technologies may be integrated into the same or different chip or set of chips and other components within network node 1760.

Processing circuitry 1770 is configured to perform any determining, calculating, or similar operations (e.g., certain obtaining operations) described herein as being provided by a network node. These operations performed by processing circuitry 1770 may include processing information obtained by processing circuitry 1770 by, for example, converting the obtained information into other information, comparing the obtained information or converted information to information stored in the network node, and/or performing one or more operations based on the obtained information or converted information, and as a result of said processing making a determination.

Processing circuitry 1770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1760 components, such as device readable medium 1780, network node 1760 functionality. For example, processing circuitry 1770 may execute instructions stored in device readable medium 1780 or in memory within processing circuitry 1770. Such functionality may include providing any of the various wireless features, functions, or benefits discussed herein. In some embodiments, processing circuitry 1770 may include a system on a chip (SOC).

In some embodiments, processing circuitry 1770 may include one or more of radio frequency (RF) transceiver circuitry 1772 and baseband processing circuitry 1774. In some embodiments, radio frequency (RF) transceiver circuitry 1772 and baseband processing circuitry 1774 may be on separate chips (or sets of chips), boards, or units, such as radio units and digital units. In alternative embodiments, part or all of RF transceiver circuitry 1772 and baseband processing circuitry 1774 may be on the same chip or set of chips, boards, or units

In certain embodiments, some or all of the functionality described herein as being provided by a network node, base station, eNB or other such network device may be performed by processing circuitry 1770 executing instructions stored on device readable medium 1780 or memory within processing circuitry 1770. In alternative embodiments, some or all of the functionality may be provided by processing circuitry 1770 without executing instructions stored on a separate or discrete device readable medium, such as in a hard-wired manner. In any of those embodiments, whether executing instructions stored on a device readable storage medium or not, processing circuitry 1770 can be configured to perform the described functionality. The benefits provided by such functionality are not limited to processing circuitry 1770 alone or to other components of network node 1760, but are enjoyed by network node 1760 as a whole, and/or by end users and the wireless network generally.

Device readable medium 1780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1770. Device readable medium 1780 may store any suitable instructions, data or information, including a computer program, software, an application including one or more of logic, rules, code, tables, etc. and/or other instructions capable of being executed by processing circuitry 1770 and, utilized by network node 1760. Device readable medium 1780 may be used to store any calculations made by processing circuitry 1770 and/or any data received via interface 1790. In some embodiments, processing circuitry 1770 and device readable medium 1780 may be considered to be integrated.

Interface 1790 is used in the wired or wireless communication of signalling and/or data between network node 1760, network 1706, and/or WDs 1710. As illustrated, interface 1790 comprises port(s)/terminal(s) 1794 to send and receive data, for example to and from network 1706 over a wired connection. Interface 1790 also includes radio front end circuitry 1792 that may be coupled to, or in certain embodiments a part of, antenna 1762. Radio front end circuitry 1792 comprises filters 1798 and amplifiers 1796. Radio front end circuitry 1792 may be connected to antenna 1762 and processing circuitry 1770. Radio front end circuitry may be configured to condition signals communicated between antenna 1762 and processing circuitry 1770. Radio front end circuitry 1792 may receive digital data that is to be sent out to other network nodes or WDs via a wireless connection. Radio front end circuitry 1792 may convert the digital data into a radio signal having the appropriate channel and bandwidth parameters using a combination of filters 1798 and/or amplifiers 1796. The radio signal may then be transmitted via antenna 1762. Similarly, when receiving data, antenna 1762 may collect radio signals which are then converted into digital data by radio front end circuitry 1792. The digital data may be passed to processing circuitry 1770. In other embodiments, the interface may comprise different components and/or different combinations of components.

In certain alternative embodiments, network node 1760 may not include separate radio front end circuitry 1792, instead, processing circuitry 1770 may comprise radio front end circuitry and may be connected to antenna 1762 without separate radio front end circuitry 1792. Similarly, in some embodiments, all or some of RF transceiver circuitry 1772 may be considered a part of interface 1790. In still other embodiments, interface 1790 may include one or more ports or terminals 1794, radio front end circuitry 1792, and RF transceiver circuitry 1772, as part of a radio unit (not shown), and interface 1790 may communicate with baseband processing circuitry 1774, which is part of a digital unit (not shown).

Antenna 1762 may include one or more antennas, or antenna arrays, configured to send and/or receive wireless signals. Antenna 1762 may be coupled to radio front end circuitry 1790 and may be any type of antenna capable of transmitting and receiving data and/or signals wirelessly. In some embodiments, antenna 1762 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1762 may be separate from network node 1760 and may be connectable to network node 1760 through an interface or port.

Antenna 1762, interface 1790, and/or processing circuitry 1770 may be configured to perform any receiving operations and/or certain obtaining operations described herein as being performed by a network node. Any information, data and/or signals may be received from a wireless device, another network node and/or any other network equipment. Similarly, antenna 1762, interface 1790, and/or processing circuitry 1770 may be configured to perform any transmitting operations described herein as being performed by a network node. Any information, data and/or signals may be transmitted to a wireless device, another network node and/or any other network equipment.

Power circuitry 1787 may comprise, or be coupled to, power management circuitry and is configured to supply the components of network node 1760 with power for performing the functionality described herein. Power circuitry 1787 may receive power from power source 1786. Power source 1786 and/or power circuitry 1787 may be configured to provide power to the various components of network node 1760 in a form suitable for the respective components (e.g., at a voltage and current level needed for each respective component). Power source 1786 may either be included in, or external to, power circuitry 1787 and/or network node 1760. For example, network node 1760 may be connectable to an external power source (e.g., an electricity outlet) via an input circuitry or interface such as an electrical cable, whereby the external power source supplies power to power circuitry 1787. As a further example, power source 1786 may comprise a source of power in the form of a battery or battery pack which is connected to, or integrated in, power circuitry 1787. The battery may provide backup power should the external power source fail. Other types of power sources, such as photovoltaic devices, may also be used.

Alternative embodiments of network node 1760 may include additional components beyond those shown in FIG. 17 that may be responsible for providing certain aspects of the network node's functionality, including any of the functionality described herein and/or any functionality necessary to support the subject matter described herein. For example, network node 1760 may include user interface equipment to allow input of information into network node 1760 and to allow output of information from network node 1760. This may allow a user to perform diagnostic, maintenance, repair, and other administrative functions for network node 1760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc., A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1710 includes antenna 1711, interface 1714, processing circuitry 1720, device readable medium 1730, user interface equipment 1732, auxiliary equipment 1734, power source 1736 and power circuitry 1737. WD 1710 may include multiple sets of one or more of the illustrated components for different wireless technologies supported by WD 1710, such as, for example, GSM, WCDMA, LTE, NR, WiFi, WIMAX, NB-IoT, or Bluetooth wireless technologies, just to mention a few. These wireless technologies may be integrated into the same or different chips or set of chips as other components within WD 1710.

Antenna 1711 may include one or more antennas or antenna arrays, configured to send and/or receive wireless signals, and is connected to interface 1714. In certain alternative embodiments, antenna 1711 may be separate from WD 1710 and be connectable to WD 1710 through an interface or port. Antenna 1711, interface 1714, and/or processing circuitry 1720 may be configured to perform any receiving or transmitting operations described herein as being performed by a WD. Any information, data and/or signals may be received from a network node and/or another WD. In some embodiments, radio front end circuitry and/or antenna 1711 may be considered an interface.

As illustrated, interface 1714 comprises radio front end circuitry 1712 and antenna 1711. Radio front end circuitry 1712 comprise one or more filters 1718 and amplifiers 1716. Radio front end circuitry 1714 is connected to antenna 1711 and processing circuitry 1720, and is configured to condition signals communicated between antenna 1711 and processing circuitry 1720. Radio front end circuitry 1712 may be coupled to or a part of antenna 1711. In some embodiments, WD 1710 may not include separate radio front end circuitry 1712; rather, processing circuitry 1720 may comprise radio front end circuitry and may be connected to antenna 1711. Similarly, in some embodiments, some or all of RF transceiver circuitry 1722 may be considered a part of interface 1714. Radio front end circuitry 1712 may receive digital data that is to be sent out to other network nodes or WDs via a wireless connection. Radio front end circuitry 1712 may convert the digital data into a radio signal having the appropriate channel and bandwidth parameters using a combination of filters 1718 and/or amplifiers 1716. The radio signal may then be transmitted via antenna 1711. Similarly, when receiving data, antenna 1711 may collect radio signals which are then converted into digital data by radio front end circuitry 1712. The digital data may be passed to processing circuitry 1720. In other embodiments, the interface may comprise different components and/or different combinations of components.

Processing circuitry 1720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1710 components, such as device readable medium 1730, WD 1710 functionality. Such functionality may include providing any of the various wireless features or benefits discussed herein. For example, processing circuitry 1720 may execute instructions stored in device readable medium 1730 or in memory within processing circuitry 1720 to provide the functionality disclosed herein.

As illustrated, processing circuitry 1720 includes one or more of RF transceiver circuitry 1722, baseband processing circuitry 1724, and application processing circuitry 1726. In other embodiments, the processing circuitry may comprise different components and/or different combinations of components. In certain embodiments processing circuitry 1720 of WD 1710 may comprise a SOC. In some embodiments, RF transceiver circuitry 1722, baseband processing circuitry 1724, and application processing circuitry 1726 may be on separate chips or sets of chips. In alternative embodiments, part or all of baseband processing circuitry 1724 and application processing circuitry 1726 may be combined into one chip or set of chips, and RF transceiver circuitry 1722 may be on a separate chip or set of chips. In still alternative embodiments, part or all of RF transceiver circuitry 1722 and baseband processing circuitry 1724 may be on the same chip or set of chips, and application processing circuitry 1726 may be on a separate chip or set of chips. In yet other alternative embodiments, part or all of RF transceiver circuitry 1722, baseband processing circuitry 1724, and application processing circuitry 1726 may be combined in the same chip or set of chips. In some embodiments, RF transceiver circuitry 1722 may be a part of interface 1714. RF transceiver circuitry 1722 may condition RF signals for processing circuitry 1720.

In certain embodiments, some or all of the functionality described herein as being performed by a WD may be provided by processing circuitry 1720 executing instructions stored on device readable medium 1730, which in certain embodiments may be a computer-readable storage medium. In alternative embodiments, some or all of the functionality may be provided by processing circuitry 1720 without executing instructions stored on a separate or discrete device readable storage medium, such as in a hard-wired manner. In any of those particular embodiments, whether executing instructions stored on a device readable storage medium or not, processing circuitry 1720 can be configured to perform the described functionality. The benefits provided by such functionality are not limited to processing circuitry 1720 alone or to other components of WD 1710, but are enjoyed by WD 1710 as a whole, and/or by end users and the wireless network generally.

Processing circuitry 1720 may be configured to perform any determining, calculating, or similar operations (e.g., certain obtaining operations) described herein as being performed by a WD. These operations, as performed by processing circuitry 1720, may include processing information obtained by processing circuitry 1720 by, for example, converting the obtained information into other information, comparing the obtained information or converted information to information stored by WD 1710, and/or performing one or more operations based on the obtained information or converted information, and as a result of said processing making a determination.

Device readable medium 1730 may be operable to store a computer program, software, an application including one or more of logic, rules, code, tables, etc. and/or other instructions capable of being executed by processing circuitry 1720. Device readable medium 1730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1720. In some embodiments, processing circuitry 1720 and device readable medium 1730 may be considered to be integrated.

User interface equipment 1732 may provide components that allow for a human user to interact with WD 1710. Such interaction may be of many forms, such as visual, audial, tactile, etc. User interface equipment 1732 may be operable to produce output to the user and to allow the user to provide input to WD 1710. The type of interaction may vary depending on the type of user interface equipment 1732 installed in WD 1710. For example, if WD 1710 is a smart phone, the interaction may be via a touch screen; if WD 1710 is a smart meter, the interaction may be through a screen that provides usage (e.g., the number of gallons used) or a speaker that provides an audible alert (e.g., if smoke is detected). User interface equipment 1732 may include input interfaces, devices and circuits, and output interfaces, devices and circuits. User interface equipment 1732 is configured to allow input of information into WD 1710, and is connected to processing circuitry 1720 to allow processing circuitry 1720 to process the input information. User interface equipment 1732 may include, for example, a microphone, a proximity or other sensor, keys/buttons, a touch display, one or more cameras, a USB port, or other input circuitry. User interface equipment 1732 is also configured to allow output of information from WD 1710, and to allow processing circuitry 1720 to output information from WD 1710. User interface equipment 1732 may include, for example, a speaker, a display, vibrating circuitry, a USB port, a headphone interface, or other output circuitry. Using one or more input and output interfaces, devices, and circuits, of user interface equipment 1732, WD 1710 may communicate with end users and/or the wireless network, and allow them to benefit from the functionality described herein.

Auxiliary equipment 1734 is operable to provide more specific functionality which may not be generally performed by WDs. This may comprise specialized sensors for doing measurements for various purposes, interfaces for additional types of communication such as wired communications etc. The inclusion and type of components of auxiliary equipment 1734 may vary depending on the embodiment and/or scenario.

Power source 1736 may, in some embodiments, be in the form of a battery or battery pack. Other types of power sources, such as an external power source (e.g., an electricity outlet), photovoltaic devices or power cells, may also be used. WD 1710 may further comprise power circuitry 1737 for delivering power from power source 1736 to the various parts of WD 1710 which need power from power source 1736 to carry out any functionality described or indicated herein. Power circuitry 1737 may in certain embodiments comprise power management circuitry. Power circuitry 1737 may additionally or alternatively be operable to receive power from an external power source; in which case WD 1710 may be connectable to the external power source (such as an electricity outlet) via input circuitry or an interface such as an electrical power cable. Power circuitry 1737 may also in certain embodiments be operable to deliver power from an external power source to power source 1736. This may be, for example, for the charging of power source 1736. Power circuitry 1737 may perform any formatting, converting, or other modification to the power from power source 1736 to make the power suitable for the respective components of WD 1710 to which power is supplied.

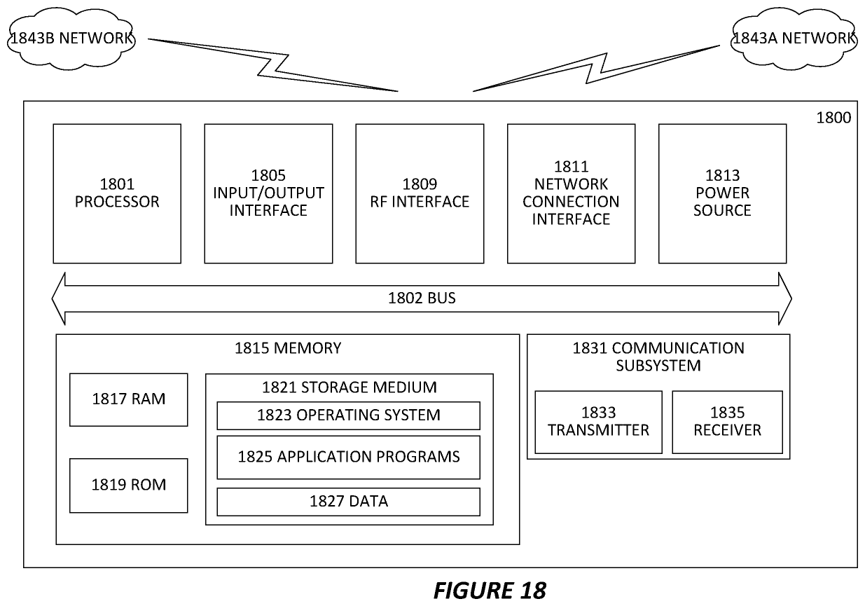

FIG. 18 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 18200 may be any UE identified by the 3rd Generation Partnership Project (3GPP), including a NB-IoT UE, a machine type communication (MTC) UE, and/or an enhanced MTC (eMTC) UE. UE 1800, as illustrated in FIG. 18, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 18 is a UE, the components discussed herein are equally applicable to a WD, and vice-versa.

In FIG. 18, UE 1800 includes processing circuitry 1801 that is operatively coupled to input/output interface 1805, radio frequency (RF) interface 1809, network connection interface 1811, memory 1815 including random access memory (RAM) 1817, read-only memory (ROM) 1819, and storage medium 1821 or the like, communication subsystem 1831, power source 1833, and/or any other component, or any combination thereof. Storage medium 1821 includes operating system 1823, application program 1825, and data 1827. In other embodiments, storage medium 1821 may include other similar types of information. Certain UEs may utilize all of the components shown in FIG. 18, or only a subset of the components. The level of integration between the components may vary from one UE to another UE. Further, certain UEs may contain multiple instances of a component, such as multiple processors, memories, transceivers, transmitters, receivers, etc.

In FIG. 18, processing circuitry 1801 may be configured to process computer instructions and data. Processing circuitry 1801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1801 may include two central processing units (CPUs). Data may be information in a form suitable for use by a computer.

In the depicted embodiment, input/output interface 1805 may be configured to provide a communication interface to an input device, output device, or input and output device. UE 1800 may be configured to use an output device via input/output interface 1805. An output device may use the same type of interface port as an input device. For example, a USB port may be used to provide input to and output from UE 1800. The output device may be a speaker, a sound card, a video card, a display, a monitor, a printer, an actuator, an emitter, a smartcard, another output device, or any combination thereof. UE 1800 may be configured to use an input device via input/output interface 1805 to allow a user to capture information into UE 1800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 18, RF interface 1809 may be configured to provide a communication interface to RF components such as a transmitter, a receiver, and an antenna. Network connection interface 1811 may be configured to provide a communication interface to network 1843a. Network 1843a may encompass wired and/or wireless networks such as a local-area network (LAN), a wide-area network (WAN), a computer network, a wireless network, a telecommunications network, another like network or any combination thereof. For example, network 1843a may comprise a Wi-Fi network. Network connection interface 1811 may be configured to include a receiver and a transmitter interface used to communicate with one or more other devices over a communication network according to one or more communication protocols, such as Ethernet, TCP/IP, SONET, ATM, or the like. Network connection interface 1811 may implement receiver and transmitter functionality appropriate to the communication network links (e.g., optical, electrical, and the like). The transmitter and receiver functions may share circuit components, software or firmware, or alternatively may be implemented separately.

RAM 1817 may be configured to interface via bus 1802 to processing circuitry 1801 to provide storage or caching of data or computer instructions during the execution of software programs such as the operating system, application programs, and device drivers. ROM 1819 may be configured to provide computer instructions or data to processing circuitry 1801. For example, ROM 1819 may be configured to store invariant low-level system code or data for basic system functions such as basic input and output (I/O), startup, or reception of keystrokes from a keyboard that are stored in a non-volatile memory. Storage medium 1821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1821 may be configured to include operating system 1823, application program 1825 such as a web browser application, a widget or gadget engine or another application, and data file 1827. Storage medium 1821 may store, for use by UE 1800, any of a variety of various operating systems or combinations of operating systems.

Storage medium 1821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1821 may allow UE 1800 to access computer-executable instructions, application programs or the like, stored on transitory or non-transitory memory media, to off-load data, or to upload data. An article of manufacture, such as one utilizing a communication system may be tangibly embodied in storage medium 1821, which may comprise a device readable medium.

In FIG. 18, processing circuitry 1801 may be configured to communicate with network 1843b using communication subsystem 1831. Network 1843a and network 1843b may be the same network or networks or different network or networks. Communication subsystem 1831 may be configured to include one or more transceivers used to communicate with network 1843b. For example, communication subsystem 1831 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1833 and/or receiver 1835 to implement transmitter or receiver functionality, respectively, appropriate to the RAN links (e.g., frequency allocations and the like). Further, transmitter 1833 and receiver 1835 of each transceiver may share circuit components, software or firmware, or alternatively may be implemented separately.

In the illustrated embodiment, the communication functions of communication subsystem 1831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1831 may include cellular communication, Wi-Fi communication, Bluetooth communication, and GPS communication. Network 1843b may encompass wired and/or wireless networks such as a local-area network (LAN), a wide-area network (WAN), a computer network, a wireless network, a telecommunications network, another like network or any combination thereof. For example, network 1843b may be a cellular network, a Wi-Fi network, and/or a near-field network. Power source 1813 may be configured to provide alternating current (AC) or direct current (DC) power to components of UE 1800.

The features, benefits and/or functions described herein may be implemented in one of the components of UE 1800 or partitioned across multiple components of UE 1800. Further, the features, benefits, and/or functions described herein may be implemented in any combination of hardware, software or firmware. In one example, communication subsystem 1831 may be configured to include any of the components described herein. Further, processing circuitry 1801 may be configured to communicate with any of such components over bus 1802. In another example, any of such components may be represented by program instructions stored in memory that when executed by processing circuitry 1801 perform the corresponding functions described herein. In another example, the functionality of any of such components may be partitioned between processing circuitry 1801 and communication subsystem 1831. In another example, the non-computationally intensive functions of any of such components may be implemented in software or firmware and the computationally intensive functions may be implemented in hardware.

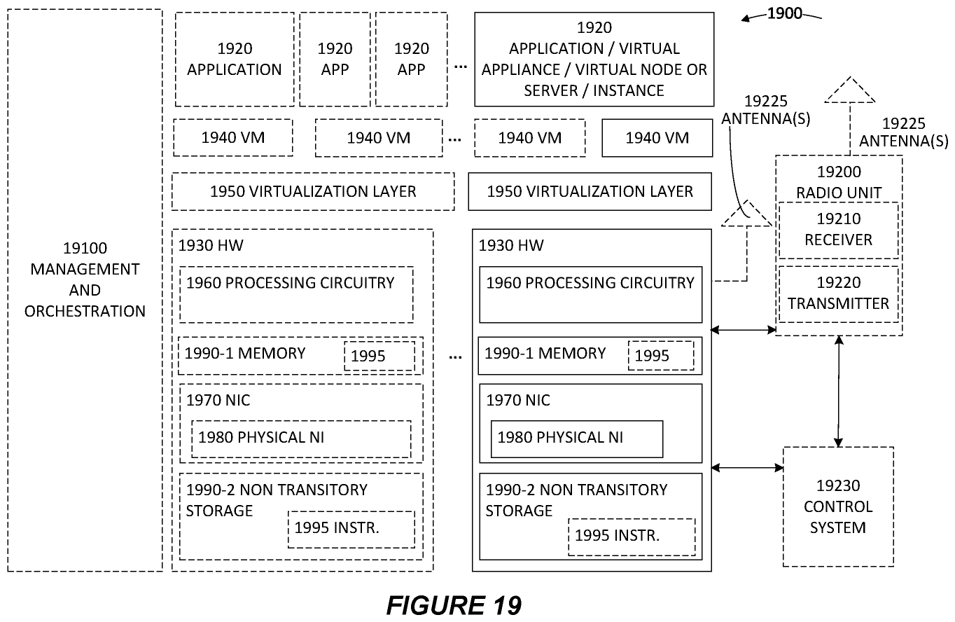

FIG. 19 is a schematic block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1900 hosted by one or more of hardware nodes 1930. Further, in embodiments in which the virtual node is not a radio access node or does not require radio connectivity (e.g., a core network node), then the network node may be entirely virtualized.

The functions may be implemented by one or more applications 1920 (which may alternatively be called software instances, virtual appliances, network functions, virtual nodes, virtual network functions, etc.) operative to implement some of the features, functions, and/or benefits of some of the embodiments disclosed herein. Applications 1920 are run in virtualization environment 1900 which provides hardware 1930 comprising processing circuitry 1960 and memory 1990. Memory 1990 contains instructions 1995 executable by processing circuitry 1960 whereby application 1920 is operative to provide one or more of the features, benefits, and/or functions disclosed herein.

Virtualization environment 1900, comprises general-purpose or special-purpose network hardware devices 1930 comprising a set of one or more processors or processing circuitry 1960, which may be commercial off-the-shelf (COTS) processors, dedicated Application Specific Integrated Circuits (ASICs), or any other type of processing circuitry including digital or analog hardware components or special purpose processors. Each hardware device may comprise memory 1990-1 which may be non-persistent memory for temporarily storing instructions 1995 or software executed by processing circuitry 1960. Each hardware device may comprise one or more network interface controllers (NICs) 1970, also known as network interface cards, which include physical network interface 1980. Each hardware device may also include non-transitory, persistent, machine-readable storage media 1990-2 having stored therein software 1995 and/or instructions executable by processing circuitry 1960. Software 1995 may include any type of software including software for instantiating one or more virtualization layers 1950 (also referred to as hypervisors), software to execute virtual machines 1940 as well as software allowing it to execute functions, features and/or benefits described in relation with some embodiments described herein.

Virtual machines 1940, comprise virtual processing, virtual memory, virtual networking or interface and virtual storage, and may be run by a corresponding virtualization layer 1950 or hypervisor. Different embodiments of the instance of virtual appliance 1920 may be implemented on one or more of virtual machines 1940, and the implementations may be made in different ways.

During operation, processing circuitry 1960 executes software 1995 to instantiate the hypervisor or virtualization layer 1950, which may sometimes be referred to as a virtual machine monitor (VMM). Virtualization layer 1950 may present a virtual operating platform that appears like networking hardware to virtual machine 1940.

As shown in FIG. 19, hardware 1930 may be a standalone network node with generic or specific components. Hardware 1930 may comprise antenna 19225 and may implement some functions via virtualization. Alternatively, hardware 1930 may be part of a larger cluster of hardware (e.g. such as in a data center or customer premise equipment (CPE)) where many hardware nodes work together and are managed via management and orchestration (MANO) 19100, which, among others, oversees lifecycle management of applications 1920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1940 may be a software implementation of a physical machine that runs programs as if they were executing on a physical, non-virtualized machine. Each of virtual machines 1940, and that part of hardware 1930 that executes that virtual machine, be it hardware dedicated to that virtual machine and/or hardware shared by that virtual machine with others of the virtual machines 1940, forms a separate virtual network elements (VNE).

Still in the context of NFV, Virtual Network Function (VNF) is responsible for handling specific network functions that run in one or more virtual machines 1940 on top of hardware networking infrastructure 1930 and corresponds to application 1920 in FIG. 19.

In some embodiments, one or more radio units 19200 that each include one or more transmitters 19220 and one or more receivers 19210 may be coupled to one or more antennas 19225. Radio units 19200 may communicate directly with hardware nodes 1930 via one or more appropriate network interfaces and may be used in combination with the virtual components to provide a virtual node with radio capabilities, such as a radio access node or a base station.

In some embodiments, some signalling can be effected with the use of control system 19230 which may alternatively be used for communication between the hardware nodes 1930 and radio units 19200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a transmit network node configured for use in a wireless communication network, the method comprising:
tunneling packets from the transmit network node to a receive network node in the wireless communication network; and
transmitting, from the transmit network node to the receive network node, signaling that indicates which tunneled packets carry application layer data from the same application layer packet, how many tunneled packets carry application layer data from the same application layer packet, and/or a size of an application layer packet.

A2. The method of embodiment A1, wherein said tunneling comprises tunneling the packets within General Packet Radio Service Tunneling Protocol, GTP, packets.

A3. The method of embodiment A2, wherein said signaling is included in GTP headers of the GTP packets that include the tunneled packets.

A4. The method of any of embodiments A1-A3, wherein the tunneled packets are Internet Protocol, IP, packets.

A5. The method of any of embodiments A1-A4, wherein the signaling indicates which tunneled packets carry application layer data from the same application layer packet.

A6. The method of embodiment A5, wherein the signaling indicates which tunneled packets carry application layer data from the same application layer packet by indicating, for each tunneled packet, whether the tunneled packet is the first packet segmented from an application layer packet and/or whether the tunneled packet is the last packet segmented from an application layer packet.

A7. The method of any of embodiments A5-A6, wherein the signaling indicates which tunneled packets carry application layer data from the same application layer packet by indicating a sequence number for each tunneled packet, wherein different sequence numbers are associated with different application layer packets.

A8. The method of any of embodiments A1-A7, wherein the signaling indicates how many tunneled packets convey application layer data from the same application layer packet.

A9. The method of any of embodiments A1-A8, wherein the signaling indicates a size of an application layer packet.

A10. The method of any of embodiments A1-A9, wherein the transmit network node is a core network node.

A11. The method of any of embodiments A1-A10, wherein the transmit network node implements a user plane function, UPF.

A12. The method of any of embodiments A1-A9, wherein the transmit network node is a radio network node.

A13. The method of any of embodiments A1-A12, wherein the receive network node is a radio network node.

A14. The method of any of embodiments A1-A13, wherein the tunneled packets are downlink packets destined for a wireless device served by the wireless communication network.

A15. The method of any of embodiments A1-A13, wherein the tunneled packets are uplink packets originating from a wireless device served by the wireless communication network.

AA. The method of any of the previous embodiments, further comprising:
providing user data; and
forwarding the user data to a host computer via the transmission to a base station.

### Group B Embodiments

B1. A method performed by a receive network node configured for use in a wireless communication network, the method comprising:
receiving, at the receive network node, packets tunneled from a transmit network node in the wireless communication network; and
receiving, at the receive network node, from the transmit network node, signaling that indicates which tunneled packets carry application layer data from the same application layer packet, how many tunneled packets carry application layer data from the same application layer packet, and/or a size of an application layer packet.

B2. The method of embodiment B1, wherein receiving packets tunneled from the transmit network node comprises receiving the packets within General Packet Radio Service Tunneling Protocol, GTP, packets.

B3. The method of embodiment B2, wherein said signaling is included in GTP headers of the GTP packets that include the tunneled packets.

B4. The method of any of embodiments B1-B3, wherein the tunneled packets are Internet Protocol, IP, packets.

B5. The method of any of embodiments B1-B4, wherein the signaling indicates which tunneled packets carry application layer data from the same application layer packet.

B6. The method of embodiment B5, wherein the signaling indicates which tunneled packets carry application layer data from the same application layer packet by indicating, for each tunneled packet, whether the tunneled packet is the first packet segmented from an application layer packet and/or whether the packet is the last packet segmented from an application layer packet.

B7. The method of any of embodiments B5-B6, wherein the signaling indicates which tunneled packets carry application layer data from the same application layer packet by indicating a sequence number for each tunneled packet, wherein different sequence numbers are associated with different application layer packets.

B8. The method of any of embodiments B1-B7, wherein the signaling indicates how many tunneled packets convey application layer data from the same application layer packet.

B9. The method of any of embodiments B1-B8, wherein the signaling indicates a size of an application layer packet.

B10. The method of any of embodiments B1-B9, wherein the transmit network node is a core network node.

B11. The method of any of embodiments B1-B10, wherein the transmit network node implements a user plane function, UPF.

B12. The method of any of embodiments B1-B9, wherein the transmit network node is a radio network node.

B13. The method of any of embodiments B1-B12, wherein the receive network node is a radio network node.

B14. The method of any of embodiments B1-B13, wherein the tunneled packets are downlink packets destined for a wireless device served by the wireless communication network.

B15. The method of any of embodiments B1-B14, further comprising, based on the signaling, scheduling transmission of the tunneled packets from the receive network node.

B16. The method of embodiment B16, wherein said scheduling comprises scheduling transmission of each tunneled packet carrying application layer data from the same application layer packet based on one or more of the same application layer quality of service requirements.

B17. The method of embodiment B16, wherein scheduling transmission of each tunneled packet carrying application layer data from the same application layer packet based on one or more of the same quality of service requirements comprises scheduling transmission of each tunneled packet carrying application layer data from the same application layer packet based on the same application layer latency requirement.

B18. The method of embodiment B17, wherein scheduling transmission of each tunneled packet carrying application layer data from the same application layer packet based on the same application layer latency requirement comprises scheduling transmission of each tunneled packet carrying application layer data from the same application layer packet based on the application layer latency requirement of whichever of the tunneled packets carrying application layer data from the same application layer packet was received at the receive network node first.

B19. The method of any of embodiments B1-B15, further comprising, based on the signaling, allocating radio resources for transmission of the tunneled packets from the receive network node towards a wireless device served by the receive network node.

B20. The method of embodiment B19, wherein said allocating comprises deciding how many radio resources to allocate for the transmission and/or when to allocate radio resources for the transmission.

B21. The method of any of embodiments B1-B13, wherein the tunneled packets are uplink packets originating from a wireless device served by the wireless communication network.

BB. The method of any of the previous embodiments, further comprising:
obtaining user data; and
forwarding the user data to a host computer or a wireless device.

### Group C Embodiments

C1. A network node configured to perform any of the steps of any of the Group A or Group B embodiments.

C2. A network node comprising processing circuitry configured to perform any of the steps of any of the Group A embodiments.

C3. A network node comprising:
communication circuitry; and
processing circuitry configured to perform any of the steps of any of the Group A embodiments.

C4. A network node comprising:
processing circuitry configured to perform any of the steps of any of the Group A embodiments; and
power supply circuitry configured to supply power to the network node.

C5. A network node comprising:
processing circuitry and memory, the memory containing instructions executable by the processing circuitry whereby the network node is configured to perform any of the steps of any of the Group A embodiments.

C6. A computer program comprising instructions which, when executed by at least one processor of a network node, causes the network node to carry out the steps of any of the Group A embodiments.

C7. A carrier containing the computer program of embodiment C6, wherein the carrier is one of an electronic signal, optical signal, radio signal, or computer readable storage medium.

1.-31. (canceled)

32. A method performed by a transmit network node configured for use in a wireless communication network, the method comprising:
tunneling packets from the transmit network node to a receive network node in the wireless communication network; and
transmitting, from the transmit network node to the receive network node, signaling that indicates which tunneled packets carry application layer data from the same application layer packet, how many tunneled packets carry application layer data from the same application layer packet, and/or a size of an application layer packet.

33. The method of claim 32, wherein said tunneling comprises tunneling the packets within General Packet Radio Service Tunneling Protocol (GTP) packets, wherein said signaling is included in GTP headers of the GTP packets that include the tunneled packets.

34. The method of claim 32, wherein the signaling indicates which tunneled packets carry application layer data from the same application layer packet, wherein the signaling indicates which tunneled packets carry application layer data from the same application layer packet by:
indicating, for each tunneled packet, whether the tunneled packet is the first packet segmented from an application layer packet and/or whether the tunneled packet is the last packet segmented from an application layer packet; and/or
indicating a sequence number for each tunneled packet, wherein different sequence numbers are associated with different application layer packets.

35. A method performed by a receive network node configured for use in a wireless communication network, the method comprising:
receiving, at the receive network node, packets tunneled from a transmit network node in the wireless communication network; and
receiving, at the receive network node, from the transmit network node, signaling that indicates which tunneled packets carry application layer data from the same application layer packet, how many tunneled packets carry application layer data from the same application layer packet, and/or a size of an application layer packet.

36. The method of claim 35, wherein receiving packets tunneled from the transmit network node comprises receiving the packets within General Packet Radio Service Tunneling Protocol (GTP) packets, wherein said signaling is included in GTP headers of the GTP packets that include the tunneled packets.

37. The method of claim 35, wherein the signaling indicates which tunneled packets carry application layer data from the same application layer packet, wherein the signaling indicates which tunneled packets carry application layer data from the same application layer packet by:
indicating, for each tunneled packet, whether the tunneled packet is the first packet segmented from an application layer packet and/or whether the packet is the last packet segmented from an application layer packet; and/or
indicating a sequence number for each tunneled packet, wherein different sequence numbers are associated with different application layer packets.

38. The method of claim 35, further comprising, based on the signaling:
scheduling transmission of the tunneled packets from the receive network node; and/or
allocating radio resources for transmission of the tunneled packets from the receive network node towards a wireless device served by the receive network node.

39. The method of claim 35, further comprising, based on the signaling:
scheduling transmission of the tunneled packets from the receive network node, wherein said scheduling comprises scheduling transmission of each tunneled packet carrying application layer data from the same application layer packet based on one or more of the same application layer quality of service requirements.

40. The method of claim 39, wherein scheduling transmission of each tunneled packet carrying application layer data from the same application layer packet based on one or more of the same quality of service requirements comprises scheduling transmission of each tunneled packet carrying application layer data from the same application layer packet based on the same application layer latency requirement.

41. The method of claim 40, wherein scheduling transmission of each tunneled packet carrying application layer data from the same application layer packet based on the same application layer latency requirement comprises scheduling transmission of each tunneled packet carrying application layer data from the same application layer packet based on the application layer latency requirement of whichever of the tunneled packets carrying application layer data from the same application layer packet was received at the receive network node first.

42. A transmit network node configured for use in a wireless communication network, the transmit network node comprising:
communication circuitry; and
processing circuitry configured to:
tunnel packets from the transmit network node to a receive network node in the wireless communication network; and
transmit, from the transmit network node to the receive network node, signaling that indicates which tunneled packets carry application layer data from the same application layer packet, how many tunneled packets carry application layer data from the same application layer packet, and/or a size of an application layer packet.

43. The transmit network node of claim 42, wherein said tunneling comprises tunneling the packets within General Packet Radio Service Tunneling Protocol (GTP) packets, wherein said signaling is included in GTP headers of the GTP packets that include the tunneled packets.

44. The transmit network node of claim 42, wherein the signaling indicates which tunneled packets carry application layer data from the same application layer packet, wherein the signaling indicates which tunneled packets carry application layer data from the same application layer packet by:
indicating, for each tunneled packet, whether the tunneled packet is the first packet segmented from an application layer packet and/or whether the tunneled packet is the last packet segmented from an application layer packet; and/or
indicating a sequence number for each tunneled packet, wherein different sequence numbers are associated with different application layer packets.

45. A receive network node configured for use in a wireless communication network, the receive network node comprising:
communication circuitry; and
processing circuitry configured to:
receive, at the receive network node, packets tunneled from a transmit network node in the wireless communication network; and
receive, at the receive network node, from the transmit network node, signaling that indicates which tunneled packets carry application layer data from the same application layer packet, how many tunneled packets carry application layer data from the same application layer packet, and/or a size of an application layer packet.

46. The receive network node of claim 45, the processing circuitry configured to receive the packets within General Packet Radio Service Tunneling Protocol (GTP) packets, wherein said signaling is included in GTP headers of the GTP packets that include the tunneled packets.

47. The receive network node of claim 45, wherein the signaling indicates which tunneled packets carry application layer data from the same application layer packet, wherein the signaling indicates which tunneled packets carry application layer data from the same application layer packet by:
indicating, for each tunneled packet, whether the tunneled packet is the first packet segmented from an application layer packet and/or whether the packet is the last packet segmented from an application layer packet; and/or
indicating a sequence number for each tunneled packet, wherein different sequence numbers are associated with different application layer packets.

48. The receive network node of claim 45, the processing circuitry configured to, based on the signaling:
schedule transmission of the tunneled packets from the receive network node; and/or
allocate radio resources for transmission of the tunneled packets from the receive network node towards a wireless device served by the receive network node.

49. The receive network node of claim 45, the processing circuitry configured to, based on the signaling schedule transmission of the tunneled packets from the receive network node, by scheduling transmission of each tunneled packet carrying application layer data from the same application layer packet based on one or more of the same application layer quality of service requirements.

50. The receive network node of claim 49, the processing circuitry configured to schedule transmission of each tunneled packet carrying application layer data from the same application layer packet based on the same application layer latency requirement.

51. The receive network node of claim 50, the processing circuitry configured to schedule transmission of each tunneled packet carrying application layer data from the same application layer packet based on the application layer latency requirement of whichever of the tunneled packets carrying application layer data from the same application layer packet was received at the receive network node first.
